(19) United States
(12) Patent Application Publication
(10) Pub. No.: US 2022/0338264 A1
(43) Pub. Date: Oct. 20, 2022

(54) METHOD FOR TRANSMITTING AND RECEIVING SIGNALS IN WIRELESS COMMUNICATION SYSTEM, AND APPARATUS THAT SUPPORTS SAME

(71) Applicant: LG ELECTRONICS INC., Seoul (KR)

(72) Inventors: Hyunsoo KO, Seoul (KR); Sukhyon YOON, Seoul (KR); Byounghoon KIM, Seoul (KR)

(73) Assignee: LG ELECTRONICS INC., Seoul (KR)

(21) Appl. No.: 17/634,888

(22) PCT Filed: Aug. 14, 2020
(86) PCT No.: PCT/KR2020/010851

§ 371 Date: Feb. 11, 2022

(30) Foreign Application Priority Data
Aug. 14, 2019 (KR) 1020190099860
Aug. 28, 2019 (KR) 1020190105931
Nov. 8, 2019 (KR) 1020190142941

(51) Int. Cl. H04W 74/08; H04W 74/00; H04W 72/04; H04W 16/14

(52) U.S. Cl. CPC H04W 74/0833; H04W 74/004; H04W 72/0446; H04W 74/008; H04W 16/14

(57) ABSTRACT

Various embodiments of the present disclosure relate to a next-generation wireless communication system for supporting higher data rates than 4th generation (4G) wireless communication systems. According to various embodiments of the present disclosure, a method for transmitting and receiving a signal in a wireless communication system, and an apparatus for supporting same may be provided.

### TECHNICAL FIELD

Embodiments of the present disclosure relate to a wireless communication system.

### BACKGROUND ART

Wireless access systems have been widely deployed to provide various types of communication services such as voice or data. In general, a wireless access system is a multiple access system that supports communication of multiple users by sharing available system resources (a bandwidth, transmission power, etc.) among them. For example, multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### DISCLOSURE

### Technical Problem

Various embodiments of the present disclosure may provide a method of transmitting and receiving a signal in a wireless communication system and an apparatus for supporting the method.

For example, various embodiments of the present disclosure may provide a method of overriding/changing/reconfiguring a parameter for configuring a PRACH occasion in a random access procedure and an apparatus for supporting the method.

For example, various embodiments of the present disclosure may provide a method of performing a random access procedure in an LTE-NR coexistence situation.

It will be appreciated by persons skilled in the art that the objects that could be achieved with the various embodiments of the present disclosure are not limited to what has been particularly described hereinabove and the above and other objects that the various embodiments of the present disclosure could achieve will be more clearly understood from the following detailed description.

### Technical Solution

Various embodiments of the present disclosure may provide a method of transmitting and receiving a signal in a wireless communication system and an apparatus for supporting the method.

Various embodiments of the present disclosure may provide a method performed by a user equipment (UE) in a wireless communication system.

According to an exemplary embodiment, the method includes receiving configuration information related to a physical random access channel (PRACH), and transmitting the PRACH in a PRACH occasion included in one or more PRACH occasions configured based on a plurality of parameters related to the configuration information.

According to an exemplary embodiment, based on reception of information related to overriding of one or more first values of one or more parameters among the plurality of parameters with one or more second values, the one or more PRACH occasions may be configured based on (i) a parameter except for the one or more parameters among the plurality of parameters and (ii) the one or more parameters overridden with the one or more second values.

According to an exemplary embodiment, the one or more first values may satisfy preconfigured correspondence between the one or more first values and the configuration information identified based on the configuration information and a preconfigured PRACH configuration table.

According to an exemplary embodiment, the information related to overriding may include information for the one or more parameters as the one or more second values.

According to an exemplary embodiment, the one or more PRACH occasions may be included in one PRACH slot.

According to an exemplary embodiment, based on reception of information for some PRACH occasions of the one or more PRACH occasions, (i) the PRACH is transmitted in the PRACH occasion included in the some PRACH occasions and a physical uplink shared channel (PUSCH) may be transmitted in a PRACH occasion except for the some PRACH occasions among the one or more PRACH occasions, or (ii) the PRACH may be transmitted in the PRACH occasion except for the some PRACH occasions among the one or more PRACH occasions, and a PUSCH is transmitted in some PRACH occasions.

According to an exemplary embodiment, transmission of the PRACH may include transmission of a PRACH preamble.

According to an exemplary embodiment, after the PRACH preamble is transmitted, a physical uplink shared channel (PUSCH) may be transmitted.

According to an exemplary embodiment, based on reception of the information related to overriding, (i) transmission of the PRACH preamble and transmission of the PUSCH may be consecutively configured on a time domain or a timing gap between transmission of the PRACH preamble and transmission of the PUSCH may be configured to be less than 16 micro-second (us).

According to an exemplary embodiment, the PRACH preamble and the PUSCH may be included in a message A.

According to an exemplary embodiment, the message A may be transmitted based on one time channel access procedure (CAP) for access to a channel included within an unlicensed band.

Various embodiments of the present disclosure may provide an apparatus operating in a wireless communication system.

According to an exemplary embodiment, the apparatus may include a memory and one or more processors connected to the memory.

According to an exemplary embodiment, the one or more processors may receive configuration information related to a physical random access channel (PRACH) and may transmit the PRACH in a PRACH occasion included in one or more PRACH occasions configured based on a plurality of parameters related to the configuration information.

According to an exemplary embodiment, based on reception of information related to overriding of one or more first values of one or more parameters among the plurality of parameters with one or more second values, the one or more PRACH occasions may be configured based on (i) a parameter except for the one or more parameters among the plurality of parameters and (ii) the one or more parameters overridden with the one or more second values.

According to an exemplary embodiment, the one or more first values may satisfy preconfigured correspondence between the one or more first values and the configuration information identified based on the configuration information and a preconfigured PRACH configuration table.

According to an exemplary embodiment, the information related to overriding may include information for the one or more parameters as the one or more second values.

According to an exemplary embodiment, the one or more PRACH occasions may be included in one PRACH slot.

According to an exemplary embodiment, based on reception of information for some PRACH occasions of the one or more PRACH occasions, (i) the PRACH may be transmitted in the PRACH occasion included in the some PRACH occasions and a physical uplink shared channel (PUSCH) is transmitted in a PRACH occasion except for the some PRACH occasions among the one or more PRACH occasions, or (ii) the PRACH may be transmitted in the PRACH occasion except for the some PRACH occasions among the one or more PRACH occasions, and a PUSCH may be transmitted in some PRACH occasions.

According to an exemplary embodiment, the apparatus may communicate with one or more of a mobile UE, a network, and an autonomous driving vehicle other than a vehicle including the apparatus.

Various embodiments of the present disclosure may provide a method performed by a base station (BS) in a wireless communication system.

According to an exemplary embodiment, the method includes transmitting configuration information related to a physical random access channel (PRACH), and receiving the PRACH in a PRACH occasion included in one or more PRACH occasion based on a plurality of parameters related to the configuration information.

According to an exemplary embodiment, in response to transmission of information related to overriding of one or more first values of one or more parameters among the plurality of parameters with one or more second values, the one or more PRACH occasions may be based on (i) a parameter except for the one or more parameters among the plurality of parameters and (ii) the one or more parameters overridden with the one or more second values.

Various embodiments of the present disclosure may provide an apparatus operating in a wireless communication system.

According to an exemplary embodiment, the apparatus includes a memory and one or more processors connected to the memory.

According to an exemplary embodiment, the one or more processors may transmit configuration information related to a physical random access channel (PRACH) and may receive the PRACH in a PRACH occasion included in one or more PRACH occasion based on a plurality of parameters related to the configuration information.

According to an exemplary embodiment, in response to transmission of information related to overriding of one or more first values of one or more parameters among the plurality of parameters with one or more second values, the one or more PRACH occasions may be based on (i) a parameter except for the one or more parameters among the plurality of parameters and (ii) the one or more parameters overridden with the one or more second values.

Various embodiments of the present disclosure may provide an apparatus operating in a wireless communication system.

According to an exemplary embodiment, the apparatus includes one or more processors, and one or more memories configured to store one or more instructions for allowing the one or more processors to perform a method.

According to an exemplary embodiment, the method includes receiving configuration information related to a physical random access channel (PRACH), and transmitting the PRACH in a PRACH occasion included in one or more PRACH occasions configured based on a plurality of parameters related to the configuration information.

According to an exemplary embodiment, based on reception of information related to overriding of one or more first values of one or more parameters among the plurality of parameters with one or more second values, the one or more PRACH occasions may be configured based on (i) a parameter except for the one or more parameters among the plurality of parameters and (ii) the one or more parameters overridden with the one or more second values.

Various embodiments of the present disclosure may provide a processor-readable medium for storing one or more instructions for allowing one or more processors to perform a method.

According to an exemplary embodiment, the method includes receiving configuration information related to a physical random access channel (PRACH), and transmitting the PRACH in a PRACH occasion included in one or more PRACH occasions configured based on a plurality of parameters related to the configuration information.

According to an exemplary embodiment, based on reception of information related to overriding of one or more first values of one or more parameters among the plurality of parameters with one or more second values, the one or more PRACH occasions may be configured based on (i) a parameter except for the one or more parameters among the plurality of parameters and (ii) the one or more parameters overridden with the one or more second values.

It will be appreciated by persons skilled in the art that the objects that could be achieved with the present disclosure are not limited to what has been particularly described hereinabove and the above and other objects that the present disclosure could achieve will be more clearly understood from the following detailed description.

### Advantageous Effects

Various embodiments of the present disclosure may provide a method of transmitting and receiving a signal in a wireless communication system and an apparatus for supporting the method.

For example, various embodiments of the present disclosure may provide a method of overriding/changing/reconfiguring a parameter for configuring a PRACH occasion in a random access procedure to effectively perform a random access procedure and an apparatus for supporting the method.

For example, various embodiments of the present disclosure may provide a method of reducing latency in a random access procedure and an apparatus for supporting the method.

For example, various embodiments of the present disclosure may provide a method of performing an effective random access procedure in an LTE-NR coexistence situation and an apparatus for supporting the method.

It will be appreciated by persons skilled in the art that that the effects that can be achieved through the various embodiments of the present disclosure are not limited to those described above and other advantageous effects of the various embodiments of the present disclosure will be more clearly understood from the following detailed description. That is, unintended effects according to implementation of the present disclosure may be derived by those skilled in the art from the various embodiments of the present disclosure.

### DESCRIPTION OF DRAWINGS

The accompanying drawings, which are included to provide a further understanding of the various embodiments of the present disclosure, provide the various embodiments of the present disclosure together with detail explanation. Yet, a technical characteristic the various embodiments of the present disclosure is not limited to a specific drawing. Characteristics disclosed in each of the drawings are combined with each other to configure a new embodiment. Reference numerals in each drawing correspond to structural elements.

FIG. 1 is a diagram illustrating physical channels and a signal transmission method using the physical channels, which may be used in various embodiments of the present disclosure;

FIG. 2 is a diagram illustrating a radio frame structure in a new radio access technology (NR) system to which various embodiments of the present disclosure are applicable;

FIG. 3 is a diagram illustrating a slot structure in an NR system to which various embodiments of the present disclosure are applicable;

FIG. 4 is a diagram illustrating mapping of physical channels in a slot, to which various embodiments are applicable.

FIG. 5 is a diagram illustrating the structure of a synchronization signal block (SSB) to which various embodiments of the present disclosure are applicable;

FIG. 6 is a diagram illustrating an exemplary SSB transmission method to which various embodiments of the present disclosure are applicable;

FIG. 7 illustrates acquisition of DL time synchronization information at a UE which various embodiments of the present disclosure are applicable;

FIG. 8 illustrates a system information (SI) acquisition procedure which various embodiments of the present disclosure are applicable.

FIG. 9 is a diagram showing an example of a wireless communication system for supporting an unlicensed band to which various embodiments of the present disclosure are applicable.

FIG. 10 is a diagram showing an example of a method of occupying a resource within an unlicensed band to which various embodiments of the present disclosure are applicable.

FIG. 11 is a diagram showing an example of the case in which a plurality of LBT-SBs is included in an unlicensed band to which various embodiments of the present disclosure are applicable.

FIG. 12 is a flowchart of a CAP operation for DL signal transmission through an unlicensed band to which various embodiments of the present disclosure are applicable.

FIG. 13 is a flowchart of a CAP operation for UL signal transmission through an unlicensed band to which various embodiments of the present disclosure are applicable.

FIG. 14 is a diagram illustrating an exemplary 4-step RACH procedure to which various embodiments of the present disclosure are applicable;

FIG. 15 is a diagram illustrating an exemplary 2-step RACH procedure to which various embodiments of the present disclosure are applicable;

FIG. 16 is a diagram illustrating an exemplary contention-free RACH procedure to which various embodiments of the present disclosure are applicable;

FIG. 17 is a diagram showing an example of an SS block and a PRACH resource linked to the SS block according to various embodiments of the present disclosure.

FIG. 18 is a diagram showing an example of an SS block and a PRACH resource linked to the SS block according to various embodiments of the present disclosure.

FIG. 19 is a diagram showing an example of a structure of an RACH occasion to which various embodiments of the present disclosure are applicable.

FIG. 20 is a schematic diagram showing an operating method of a UE and a base station (BS) according to various embodiments of the present disclosure.

FIG. 21 is a flowchart showing an operating method of a UE according to various embodiments of the present disclosure.

FIG. 22 is a flowchart showing an operating method of a BS according to various embodiments of the present disclosure.

FIG. 23 is a diagram showing an example of a configuration of an RACH occasion to which various embodiments of the present disclosure are applicable.

FIG. 24 is a diagram showing an example of an RACH occasion configuration modification according to various embodiments of the present disclosure.

FIG. 25 is a flowchart showing an operating method of a first UE according to various embodiments of the present disclosure.

FIG. 26 is a flowchart showing an operating method of a second UE according to various embodiments of the present disclosure.

FIG. 27 is a flowchart showing an operating method of a BS according to various embodiments of the present disclosure.

FIG. 28 is a schematic diagram showing an operating method of a UE and a BS according to various embodiments of the present disclosure.

FIG. 29 is a flowchart showing an operating method of a UE according to various embodiments of the present disclosure.

FIG. 30 is a flowchart showing an operating method of a BS according to various embodiments of the present disclosure.

FIG. 31 is a diagram illustrating devices that implement various embodiments of the present disclosure.

FIG. 32 illustrates an exemplary communication system to which various embodiments of the present disclosure are applied.

FIG. 33 illustrates exemplary wireless devices to which various embodiments of the present disclosure are applicable.

FIG. 34 illustrates other exemplary wireless devices to which various embodiments of the present disclosure are applied.

FIG. 35 illustrates an exemplary portable device to which various embodiments of the present disclosure are applied.

FIG. 36 illustrates an exemplary vehicle or autonomous driving vehicle to which various embodiments of the present disclosure.

### MODE FOR DISCLOSURE

Various embodiments are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

Various embodiments are described in the context of a 3GPP communication system (e.g., including LTE, NR, 6G, and next-generation wireless communication systems) for clarity of description, to which the technical spirit of the various embodiments is not limited. For the background art, terms, and abbreviations used in the description of the various embodiments, refer to the technical specifications published before the present disclosure. For example, the documents of 3GPP TS 36.211, 3GPP TS 36.212, 3GPP TS 36.213, 3GPP TS 36.300, 3GPP TS 36.321, 3GPP TS 36.331, 3GPP TS 36.355, 3GPP TS 36.455, 3GPP TS 37.355, 3GPP TS 37.455, 3GPP TS 38.211, 3GPP TS 38.212, 3GPP TS 38.213, 3GPP TS 38.214, 3GPP TS 38.215, 3GPP TS 38.300, 3GPP TS 38.321, 3GPP TS 38.331, 3GPP TS 38.355, 3GPP TS 38.455, and so on may be referred to.

### 1. 3GPP System

### 1.1. Physical Channels and Signal Transmission and Reception

In a wireless access system, a UE receives information from a BS on a DL and transmits information to the BS on a UL. The information transmitted and received between the UE and the BS includes general data information and various types of control information. There are many physical channels according to the types/usages of information transmitted and received between the BS and the UE.

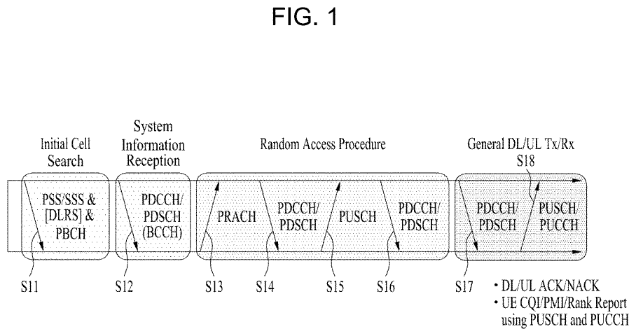

FIG. 1 is a diagram illustrating physical channels and a signal transmission method using the physical channels, which may be used in various embodiments of the present disclosure.

When a UE is powered on or enters a new cell, the UE performs initial cell search (S11). The initial cell search involves acquisition of synchronization to a BS. Specifically, the UE synchronizes its timing to the BS and acquires information such as a cell identifier (ID) by receiving a primary synchronization channel (P-SCH) and a secondary synchronization channel (S-SCH) from the BS.

Then the UE may acquire information broadcast in the cell by receiving a physical broadcast channel (PBCH) from the BS.

During the initial cell search, the UE may monitor a DL channel state by receiving a downlink reference signal (DL RS).

After the initial cell search, the UE may acquire more detailed system information by receiving a physical downlink control channel (PDCCH) and receiving on a physical downlink shared channel (PDSCH) based on information of the PDCCH (S12).

Subsequently, to complete connection to the BS, the UE may perform a random access procedure with the BS (S13 to S16). In the random access procedure, the UE may transmit a preamble on a physical random access channel (PRACH) (S13) and may receive a PDCCH and a random access response (RAR) for the preamble on a PDSCH associated with the PDCCH (S14). The UE may transmit a PUSCH by using scheduling information in the RAR (S15), and perform a contention resolution procedure including reception of a PDCCH signal and a PDSCH signal corresponding to the PDCCH signal (S16).

When the random access procedure is performed in two steps, steps S13 and S15 may be performed in one operation for a UE transmission, and steps S14 and S16 may be performed in one operation for a BS transmission.

After the above procedure, the UE may receive a PDCCH and/or a PDSCH from the BS (S17) and transmit a physical uplink shared channel (PUSCH) and/or a physical uplink control channel (PUCCH) to the BS (S18), in a general UL/DL signal transmission procedure.

Control information that the UE transmits to the BS is generically called UCI. The UCI includes a hybrid automatic repeat and request acknowledgement/negative acknowledgement (HARQ-ACK/NACK), a scheduling request (SR), a channel quality indicator (CQI), a precoding matrix index (PMI), a rank indicator (RI), etc.

In general, UCI is transmitted periodically on a PUCCH. However, if control information and traffic data should be transmitted simultaneously, the control information and traffic data may be transmitted on a PUSCH. In addition, the UCI may be transmitted aperiodically on the PUSCH, upon receipt of a request/command from a network.

### 1.2. Radio Frame Structures

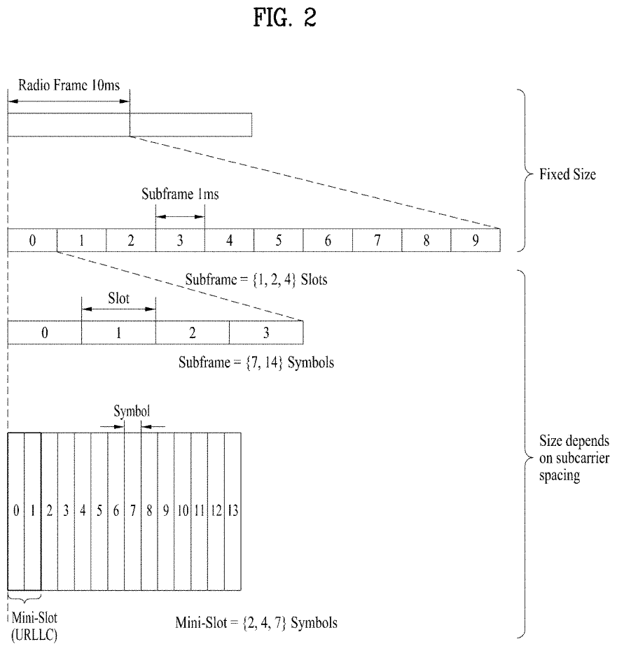

FIG. 2 is a diagram illustrating a radio frame structure in an NR system to which various embodiments of the present disclosure are applicable.

The NR system may support multiple numerologies. A numerology may be defined by a subcarrier spacing (SCS) and a cyclic prefix (CP) overhead. Multiple SCSs may be derived by scaling a default SCS by an integer N (or μ). Further, even though it is assumed that a very small SCS is not used in a very high carrier frequency, a numerology to be used may be selected independently of the frequency band of a cell. Further, the NR system may support various frame structures according to multiple numerologies.

Now, a description will be given of OFDM numerologies and frame structures which may be considered for the NR system. Multiple OFDM numerologies supported by the NR system may be defined as listed in Table 1. For a bandwidth part (BWP), μ and a CP are obtained from RRC parameters provided by the BS.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

In NR, multiple numerologies (e.g., SCSs) are supported to support a variety of 5G services. For example, a wide area in cellular bands is supported for an SCS of 15 kHz, a dense-urban area, a lower latency, and a wider carrier bandwidth are supported for an SCS of 30 kHz/60 kHz, and a larger bandwidth than 24.25 GHz is supported for an SCS of 60 kHz or more, to overcome phase noise.

An NR frequency band is defined by two types of frequency ranges, FR1 and FR2. FR1 may be a sub-6 GHz range, and FR2 may be an above-6 GHz range, that is, a millimeter wave (mmWave) band.

Table 2 below defines the NR frequency band, by way of example.

TABLE 2

| Frequency range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

Regarding a frame structure in the NR system, the time-domain sizes of various fields are represented as multiples of a basic time unit for NR, T_{c}=1/(Δfₘₐₓ*N_{f}) where Δfₘₐₓ=480*10³ Hz and a value N_{f} related to a fast Fourier transform (FFT) size or an inverse fast Fourier transform (IFFT) size is given as N_{f}=4096. T_{c} and Tₛ which is an LTE-based time unit and sampling time, given as Tₛ=1/((15 kHz)*2048) are placed in the following relationship: Tₛ/T_{c}=64. DL and UL transmissions are organized into (radio) frames each having a duration of T_{f}=(Δfₘₐₓ*N_{f}/100)*T_{c}=10 ms. Each radio frame includes 10 subframes each having a duration of T_{sf}=(Δfₘₐₓ*N_{f}/1000)*T_{c}=1 ms. There may exist one set of frames for UL and one set of frames for DL. For a numerology μ, slots are numbered with n^{μ}ₛ∈{0, . . . , N^{slot,μ}_{subfram}−1} in an increasing order in a subframe, and with n^{μ}_{s,f}∈{0, . . . , N^{slot,μ}_{frame}−1} in an increasing order in a radio frame. One slot includes n^{μ}_{symb} consecutive OFDM symbols, and N^{μ}_{symb} depends on a CP. The start of a slot n^{μ}ₛ in a subframe is aligned in time with the start of an OFDM symbol n^{μ}ₛ*N^{μ}_{symb} in the same subframe.

Table 3 lists the number of symbols per slot, the number of slots per frame, and the number of slots per subframe, for each SCS in a normal CP case, and Table 4 lists the number of symbols per slot, the number of slots per frame, and the number of slots per subframe, for each SCS in an extended CP case.

TABLE 3

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame,μ} | Nₛₗₒₜ^{subframe,μ} |
|---|---|---|---|
| 2 | 12 | 40 | 4 |

In the above tables, N^{slot}_{symb} represents the number of symbols in a slot, N^{frame,μ}ₛₗₒₜ represents the number of slots in a frame, and N^{subframe,μ}ₛₗₒₜ represents the number of slots in a subframe.

In the NR system to which various embodiments of the present disclosure are applicable, different OFDM(A) numerologies (e.g., SCSs, CP lengths, and so on) may be configured for a plurality of cells which are aggregated for one UE. Accordingly, the (absolute time) period of a time resource including the same number of symbols (e.g., a subframe (SF), a slot, or a TTI) (generically referred to as a time unit (TU), for convenience) may be configured differently for the aggregated cells.

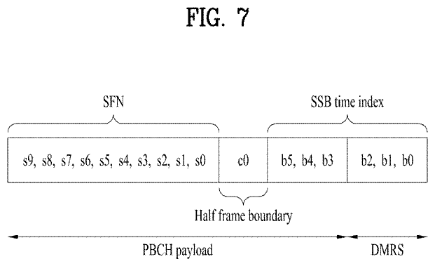

FIG. 2 illustrates an example with μ=2 (i.e., an SCS of 60 kHz), in which referring to Table 6, one subframe may include four slots. One subframe={1, 2, 4} slots in FIG. 7, which is exemplary, and the number of slot(s) which may be included in one subframe is defined as listed in Table 3 or Table 4.

Further, a mini-slot may include 2, 4 or 7 symbols, fewer symbols than 2, or more symbols than 7.

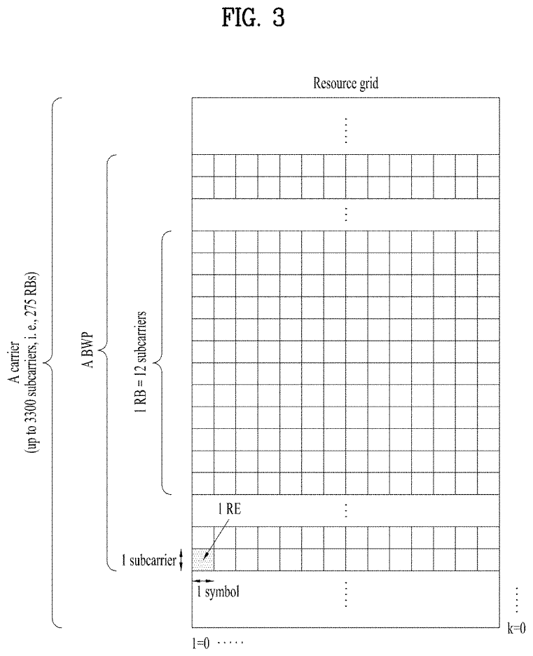

FIG. 3 is a diagram illustrating a slot structure in an NR system to which various embodiments of the present disclosure are applicable.

Referring FIG. 3, one slot includes a plurality of symbols in the time domain. For example, one slot includes 7 symbols in a normal CP case and 6 symbols in an extended CP case.

A carrier includes a plurality of subcarriers in the frequency domain. An RB is defined by a plurality of (e.g., 12) consecutive subcarriers in the frequency domain.

ABWP, which is defined by a plurality of consecutive (P)RBs in the frequency domain, may correspond to one numerology (e.g., SCS, CP length, and so on).

A carrier may include up to N (e.g., 5) BWPs. Data communication may be conducted in an activated BWP, and only one BWP may be activated for one UE. In a resource grid, each element is referred to as an RE, to which one complex symbol may be mapped.

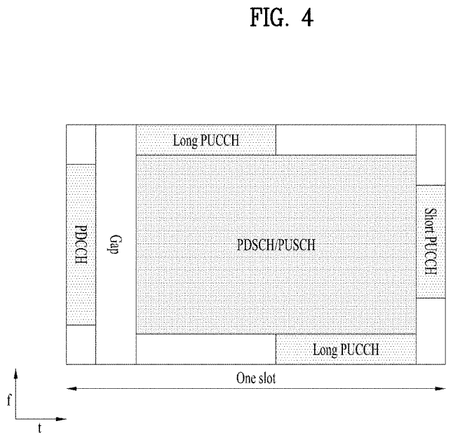

FIG. 4 is a diagram illustrating exemplary mapping of physical channels in a slot, to which various embodiments are applicable.

One slot may include all of a DL control channel, DL or UL data, and a UL control channel. For example, the first N symbols of a slot may be used to transmit a DL control channel (hereinafter, referred to as a DL control region), and the last M symbols of the slot may be used to transmit a UL control channel (hereinafter, referred to as a UL control region). Each of N and M is an integer equal to or larger than 0. A resource area (hereinafter, referred to as a data region) between the DL control region and the UL control region may be used to transmit DL data or UL data. There may be a time gap for DL-to-UL or UL-to-DL switching between a control region and a data region. A PDCCH may be transmitted in the DL control region, and a PDSCH may be transmitted in the DL data region. Some symbols at a DL-to-UL switching time in the slot may be used as the time gap.

### 1.3. Channel Structures

### 1.3.1. DL Channel Structures

The BS transmits related signals to the UE on DL channels as described below, and the UE receives the related signals from the BS on the DL channels.

### 1.3.1.1. Physical Downlink Shared Channel (PDSCH)

The PDSCH conveys DL data (e.g., DL-shared channel transport block (DL-SCH TB)) and uses a modulation scheme such as quadrature phase shift keying (QPSK), 16-ary quadrature amplitude modulation (16QAM), 64QAM, or 256QAM. A TB is encoded into a codeword. The PDSCH may deliver up to two codewords. Scrambling and modulation mapping are performed on a codeword basis, and modulation symbols generated from each codeword are mapped to one or more layers (layer mapping). Each layer together with a demodulation reference signal (DMRS) is mapped to resources, generated as an OFDM symbol signal, and transmitted through a corresponding antenna port.

### 1.3.1.2. Physical Downlink Control Channel (PDCCH)

The PDCCH may deliver downlink control information (DCI), for example, DL data scheduling information, UL data scheduling information, and so on. The PUCCH may deliver uplink control information (UCI), for example, an ACK/NACK information for DL data, channel state information (CSI), a scheduling request (SR), and so on.

The PDCCH carries DCI and is modulated in QPSK. One PDCCH includes 1, 2, 4, 8, or 16 control channel elements (CCEs) according to an aggregation level (AL). One CCE includes 6 resource element groups (REGs). One REG is defined by one OFDM symbol by one (P)RB.

The PDCCH is transmitted in a control resource set (CORESET). A CORESET is defined as a set of REGs having a given numerology (e.g., SCS, CP length, and so on). A plurality of CORESETs for one UE may overlap with each other in the time/frequency domain. A CORESET may be configured by system information (e.g., a master information block (MIB)) or by UE-specific higher layer (RRC) signaling. Specifically, the number of RBs and the number of symbols (up to 3 symbols) included in a CORESET may be configured by higher-layer signaling.

The UE acquires DCI delivered on a PDCCH by decoding (so-called blind decoding) a set of PDCCH candidates. A set of PDCCH candidates decoded by a UE are defined as a PDCCH search space set. A search space set may be a common search space (CSS) or a UE-specific search space (USS). The UE may acquire DCI by monitoring PDCCH candidates in one or more search space sets configured by an MIB or higher-layer signaling. Each CORESET configuration is associated with one or more search space sets, and each search space set is associated with one CORESET configuration.

Table 5 lists exemplary features of the respective search space types.

TABLE 5

| | Search | | |
|---|---|---|---|
| Type | Space | RNTI | Use Case |
| Type0-PDCCH | Common | SI-RNTI on a primary cell | SIB Decoding |
| Type0A-PDCCH | Common | SI-RNTI on a primary cell | SIB Decoding |
| Type1-PDCCH | Common | RA-RNTI or TC-RNTI on a | Msg2, Msg4 |
| | | primary cell | decoding in RACH |
| Type2-PDCCH | Common | P-RNTI on a primary cell | Paging Decoding |
| Type3-PDCCH | Common | INT-RNTI, SFI-RNTI, TPC-PUSCH- | |
| | | RNTI, TPC-PUCCH-RNTI, TPC-SRS- | |
| | | RNTI, C-RNTI, MCS-C-RNTI, or | |
| | | CS-RNTI(s) | |
| | UE | C-RNTI, or MCS-C-RNTI, or | User specific |
| | Specific | CS-RNTI(s) | PDSCH decoding |

Table 6 lists exemplary DCI formats transmitted on the PDCCH.

TABLE 6

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH. DCI format 2_0 is used to deliver dynamic slot format information (e.g., a dynamic slot format indicator (SFI)) to the UE, and DCI format 2_1 is used to deliver DL preemption information to the UE. DCI format 2_0 and/or DCI format 2_1 may be delivered to the UEs of a group on a group common PDCCH (GC-PDCCH) which is a PDCCH directed to a group of UEs.

### 1.3.2. UL Channel Structures

The UE transmits related signals on later-described UL channels to the BS, and the BS receives the related signals on the UL channels from the UE.

### 1.3.2.1. Physical Uplink Shared Channel (PUSCH)

The PUSCH delivers UL data (e.g., a UL-shared channel transport block (UL-SCH TB)) and/or UCI, in cyclic prefix-orthogonal frequency division multiplexing (CP-OFDM) waveforms or discrete Fourier transform-spread-orthogonal division multiplexing (DFT-s-OFDM) waveforms. If the PUSCH is transmitted in DFT-s-OFDM waveforms, the UE transmits the PUSCH by applying transform precoding. For example, if transform precoding is impossible (e.g., transform precoding is disabled), the UE may transmit the PUSCH in CP-OFDM waveforms, and if transform precoding is possible (e.g., transform precoding is enabled), the UE may transmit the PUSCH in CP-OFDM waveforms or DFT-s-OFDM waveforms. The PUSCH transmission may be scheduled dynamically by a UL grant in DCI or semi-statically by higher-layer signaling (e.g., RRC signaling) (and/or layer 1 (L1) signaling (e.g., a PDCCH)) (a configured grant). The PUSCH transmission may be performed in a codebook-based or non-codebook-based manner.

### 1.3.2.2. Physical Uplink Control Channel (PUCCH)

The PUCCH delivers UCI, an HARQ-ACK, and/or an SR and is classified as a short PUCCH or a long PUCCH according to the transmission duration of the PUCCH. Table 7 lists exemplary PUCCH formats.

TABLE 7

| | Length in | | | |
|---|---|---|---|---|
| | OFDM | Number | | |
| PUCCH | symbols | of | | |
| format | N_{symb}^{PUCCH} | bits | Usage | Etc |
| 0 | 1-2 | ≤2 | HARQ, SR | Sequence |
| | | | | selection |
| 1 | 4-14 | ≤2 | HARQ, [SR] | Sequence |
| | | | | modulation |
| 2 | 1-2 | >2 | HARQ, CSI, [SR] | CP-OFDM |
| 3 | 4-14 | >2 | HARQ, CSI, [SR] | DFT-S-OFDM |
| | | | | (no UE |
| | | | | multiplexing) |
| 4 | 4-14 | >2 | HARQ, CSI, [SR] | DFT-s-OFDM |
| | | | | (Pre DFT OCC) |

PUCCH format 0 conveys UCI of up to 2 bits and is mapped in a sequence-based manner, for transmission. Specifically, the UE transmits specific UCI to the BS by transmitting one of a plurality of sequences on a PUCCH of PUCCH format 0. Only when the UE transmits a positive SR, the UE transmits the PUCCH of PUCCH format 0 in a PUCCH resource for a corresponding SR configuration.

PUCCH format 1 conveys UCI of up to 2 bits and modulation symbols of the UCI are spread with an OCC (which is configured differently whether frequency hopping is performed) in the time domain. The DMRS is transmitted in a symbol in which a modulation symbol is not transmitted (i.e., transmitted in time division multiplexing (TDM)).

PUCCH format 2 conveys UCI of more than 2 bits and modulation symbols of the DCI are transmitted in frequency division multiplexing (FDM) with the DMRS. The DMRS is located in symbols #1, #4, #7, and #10 of a given RB with a density of 1/3. A pseudo noise (PN) sequence is used for a DMRS sequence. For 1-symbol PUCCH format 2, frequency hopping may be activated.

PUCCH format 3 does not support UE multiplexing in the same PRBS, and conveys UCI of more than 2 bits. In other words, PUCCH resources of PUCCH format 3 do not include an OCC. Modulation symbols are transmitted in TDM with the DMRS.

PUCCH format 4 supports multiplexing of up to 4 UEs in the same PRBS, and conveys UCI of more than 2 bits. In other words, PUCCH resources of PUCCH format 3 include an OCC. Modulation symbols are transmitted in TDM with the DMRS.

### 1.4. Synchronization Signal Block (SSB) Transmission and Related Operation

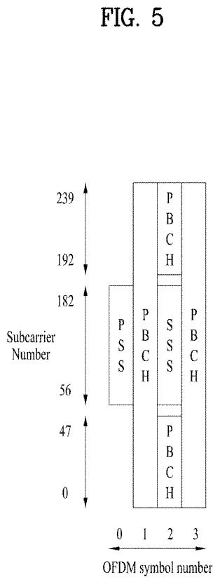

FIG. 5 is a diagram illustrating the structure of a synchronization signal block (SSB) to which various embodiments of the present disclosure are applicable.

A UE may perform cell search, system information acquisition, beam alignment for initial access, DL measurement, and so on based on an SSB. The term SSB is interchangeably used with synchronization signal/physical broadcast channel (SS/PBCH) block.

Referring to FIG. 5, the SSB to which various embodiments of the present disclosure are applicable may include 20 RBs in four consecutive OFDM symbols. Further, the SSB may include a PSS, an SSS, and a PBCH, and the UE may perform cell search, system information acquisition, beam alignment for initial access, DL measurement, and so on based on the SSB.

Each of the PSS and the SSS includes one OFDM symbol by 127 subcarriers, and the PBCH includes three OFDM symbols by 576 subcarriers. Polar coding and QPSK are applied to the PBCH. The PBCH includes data REs and DMRS REs in every OFDM symbol. There are three DMRS REs per RB, with three data REs between every two adjacent DMRS REs.

Cell Search

Cell search refers to a procedure in which the UE acquires time/frequency synchronization of a cell and detects a cell ID (e.g., physical layer cell ID (PCID)) of the cell. The PSS may be used to detect a cell ID within a cell ID group, and the SSS may be used to detect the cell ID group. The PBCH may be used in detecting an SSB (time) index and a half-frame.

The cell search procedure of the UE may be summarized as described in Table 8 below.

TABLE 8

| | Type of | |
|---|---|---|
| | Signals | Operations |
| 1^{st} | PSS | SS/PBCH block (SSB) symbol timing |
| step | | acquisition |
| | | Cell ID detection within a cell ID group |
| | | (3 hypothesis) |
| 2^{nd} | SSS | Cell ID group detection (336 hypothesis) |
| Step | | |
| 3^{rd} | PBCH DMRS | SSB index and Half frame (HF) index |
| Step | | (Slot and frame boundary detection) |
| 4^{th} | PBCH | Time information (80 ms, System Frame |
| Step | | Number (SFN), SSB index, HF) |
| | | Remaining Minimum System Information |
| | | (RMSI) Control resource set |
| | | (CORESET)/Search space configuration |
| 5^{th} | PDCCH and | Cell access information |
| Step | PDSCH | RACH configuration |

There are 336 cell ID groups each including three cell IDs. There are 1008 cell IDs in total. Information about a cell ID group to which the cell ID of a cell belongs may be provided/obtained through the SSS of the cell, and information about the cell ID among 336 cells in the cell ID may be provided/obtained through the PSS.

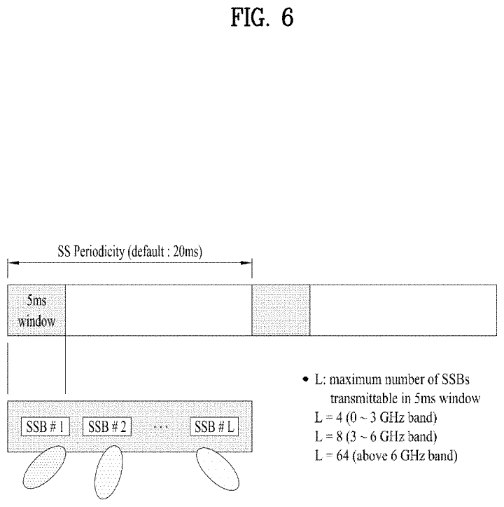

FIG. 6 is a diagram illustrating an exemplary SSB transmission method to which various embodiments of the present disclosure are applicable.

Referring to FIG. 6, the SSB is periodically transmitted according to an SSB periodicity. A default SSB periodicity assumed by the UE during initial cell search is defined as 20 ms. After the cell access, the SSB periodicity may be set to one of {5 ms, 10 ms, 20 ms, 40 ms, 80 ms, 160 ms} by the network (e.g., the BS). An SSB burst set is configured at the beginning of an SSB period. The SSB burst set may be configured with a 5-ms time window (i.e., half-frame), and an SSB may be repeatedly transmitted up to L times within the SS burst set. The maximum number of transmissions of the SSB, L may be given according to the frequency band of a carrier as follows. One slot includes up to two SSBs.

For frequency range up to 3 GHz, L=4

For frequency range from 3 GHz to 6 GHz, L=8

For frequency range from 6 GHz to 52.6 GHz, L=64

The time position of an SSB candidate in the SS burst set may be defined according to an SCS as follows. The time positions of SSB candidates are indexed as (SSB indexes) 0 to L−1 in time order within the SSB burst set (i.e., half-frame). In the description of various embodiments of the present disclosure, the candidate SSB and the SSB candidate may be interchangeably used.

Case A: 15-kHz SCS: The indexes of the first symbols of candidate SSBs are given as {2, 8}+14*n

for operation without shared spectrum channel access (e.g., L-band and LCell): where n=0, 1 for a carrier frequency equal to or less than 3 GHz and n=0, 1, 2, 3 for a carrier frequency of 3 GHz to 6 GHz.

For operation with shared spectrum channel access (e.g., U-band and UCell): where n=0, 1, 2, 3, 4.

Case B: 30-kHz SCS: The indexes of the first symbols of candidate SSBs are given as {4, 8, 16, 20}+28*n where n =0 for a carrier frequency equal to or lower than 3 GHz, and n=0, 1 for a carrier frequency of 3 GHz to 6 GHz.

Case C: 30-kHz SCS: The indexes of the first symbols of candidate SSBs are given as {2, 8}+14*n

For operation without shared spectrum channel access: (1) In the case of a paired spectrum operation where n=0, if for a carrier frequency equal to or less than 3 GHz and n=0, 1, 2, 3 for a carrier frequency within FR1 and greater than 3 GHz. (2) In the case of a non-paired spectrum operation, where n=0, 1 for a carrier frequency equal to or less than 2.4 GHz and n=0, 1, 2, 3 for a carrier frequency within FR1 and greater than 2.4 GHz.

For operation with shared spectrum channel access: where n=0, 1, 2, 3, 4, 6, 7, 8, 9.

Case D: 120-kHz SCS: The indexes of the first symbols of candidate SSBs are given as {4, 8, 16, 20}+28*n where n=0, 1, 2, 3, 5, 6, 7, 8, 10, 11, 12, 13, 15, 16, 17, 18 for a carrier frequency above 6 GHz.

Case E: 240-kHz SCS: The indexes of the first symbols of candidate SSBs are given as {8, 12, 16, 20, 32, 36, 40, 44}+56*n where n=0, 1, 2, 3, 5, 6, 7, 8 for a carrier frequency above 6 GHz.

Synchronization Procedure

FIG. 7 illustrates acquisition of DL time synchronization information at a UE which various embodiments of the present disclosure are applicable.

The UE may obtain DL synchronization by detecting an SSB. The UE may identify the structure of an SSB burst set based on the index of the detected SSB and thus detect a symbol, slot, or half-frame boundary. The number of a frame or half-frame to which the detected SSB belongs to may be identified by SFN information and half-frame indication information.

Specifically, the UE may obtain 10-bit SFN system information s0 to s9 from the PBCH. 6 bits out of the 10-bit SFN information is obtained from a master information block (MIB), and the remaining 4 bits are obtained from a PBCH transport block (TB).

The UE may then obtain 1-bit half-frame indication information c0. When a carrier frequency is 3 GHz or below, the half-frame indication information may be signaled implicitly by a PBCH DMRS. The PBCH DMRS uses one of 8 PBCH DMRS sequences to indicate 3-bit information. Therefore, when L=4, the remaining one bit except for bits indicating an SSB index among 3 bits that may be indicated by the 8 PBCH DMRS sequences may be used as a half-frame indication.

Finally, the UE may obtain an SSB index based on the DMRS sequence and PBCH payload. SSB candidates are indexed with 0 to L−1 in time order in an SSB burst set (i.e., half-frame). When L=8 or L=64, three least significant bits (LSBs) b0, b1 and b2 of an SSB index may be indicated by 8 different PBCH DMRS sequences. When L=64, three most significant bits (MSBs) b3, b4 and b5 of the SSB index are indicated by the PBCH. When L=2, two LSBs b0 and b1 of the SSB index may be indicated by 4 different PBCH DMRS sequences. When L=4, the remaining one bit b2 except for the bits indicating the SSB index among the three bits may be used as a half-frame indication.

System Information Acquisition

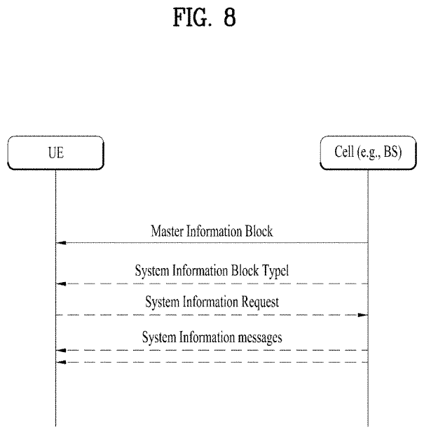

FIG. 8 illustrates a system information (SI) acquisition procedure which various embodiments of the present disclosure are applicable.

The UE may obtain access stratum (AS)-/non-access stratum (NAS)-information in the SI acquisition procedure. The SI acquisition procedure may be applied to UEs in RRC IDLE, RRC_INACTIVE, and RRC_CONNECTED states.

The SI may be divided into a Master Information Block (MIB) and a plurality of System Information Blocks (SIBs). The SI other than the MIB may be referred to as Remaining Minimum System Information (RMSI), which will be described below in detail.

The MIB may include information/parameters related to reception of SystemInformationBlockType1 (SIB1) and may be transmitted through the PBCH of the SSB.

The MIB may include information/parameters related to reception of SystemInformationBlockType1 (SIB1) and may be transmitted through the PBCH of the SSB. Information of the MIB may be understood with reference to 3GPP TS 38.331 and may include the following fields.

| | |
|---|---|
| subCarrierSpacingCommon | ENUMERATED {scs15or60, scs30or120}, |
| ssb-SubcarrierOffset | INTEGER (0 . . . 15), |
| pdcch-ConfigSIB1 | INTEGER (0 . . . 255), |
| dmrs-TypeA-Position | ENUMERATED {pos2, pos3}, |
| . . . | |
| spare BIT STRING (SIZE (1)) | |

Descriptions of the fields are shown in Table 9 below.

TABLE 9
pdech - CoufigSIB1
Determines a common ControlResourceSet (CORESET), a common search space and necessary PDCCH
parameters. If the field ssb-SubcarrierOffset indicates that SIB1 is absent, the field pdcch-ConfigSIB1 indicates
the frequency positions where the UE may find SS/PBCH block with SIB1 or the frequence range where the
network does not provide SS/PBCH block with SIB1 (see TS 38.213, clause 13).
ssb-SubcarrierOffset
Corresponds to kssa (see TS 38.213), which is the frequency domain offset between SSB and the overall
resource block grid in number of subcarriers. (See TS 38.211. clause 7.4.3.1)
The value range of this field may be extended by an additional most significant bit encoded within PBCH as
specified in TS 38.213.
This field may indicate that this cell does not provide SIB1 and that there is hence no CORESET#0 configured in
MIB (see TS 38.213, clause 13). In this case, the field pdcch-ConfigSIB1 may indicate the frequency positions
where the UE may (not) find a SS/PBCH with a control resource set and search space for SIB1 (see TS 38.213,
clause 13).
Subcarrier spacing for SIB1, Msg.2/4 for initial access, paging and broadcast SI-messages. If the UE acquires
this MIB on as FR1 carrier frequency, the value scs15or60 corresponds to 15 kHz and the value scs30or120
corresponds to 30 kHz. If the UE acquires this MIB on an FR2 carrier frequency, the value scs15or60
corresponds to 60 kHz and the value scs30or120 corresponds to 120 kHz.
dmrs-TypeA-Position
Position of (first) DM-RS for downlink (e.g., PDSCH) and uplink (e.g., PUSCH) pos2 represents the 2^{nd} symbol
in a slot and pos2 represents the 3^{rd} symbol in a slot.

When selecting an initial cell, the UE may assume that a half-frame having the SSB is repeated at a period of 20 ms. The UE may check whether a Control Resource Set (CORESET) (e.g., CORESET#0) for a Type0-PDCCH common search space is present based on the MIB. In k_{SSB}<=23 (for FR1) or k_{SSB}<=11 (for FR2), the UE may determine that the CORESET for the Type0-PDCCH common search space is present. In the case of k_{SSB}>23 (for FR1) or k_{SSB}>11 (for FR2), the UE may determine that the CORESET for the Type0-PDCCH common search space is not present. The Type0-PDCCH common search space may be a type of a PDCCH search space and may be used to transmit a PDCCH for scheduling an SI message.

When the Type0-PDCCH common search space is present, the UE may determine (i) a plurality of consecutive RBs included in the CORESET (e.g., CORESET#0) and one or more consecutive symbols and (ii) a PDCCH occasion (i.e., a location in the time domain for reception of the PDCCH) (e.g., search space#0) based on information in the MIB (e.g., pdcch-ConfigSIB1). When the Type0-PDCCH common search space is not present, the pdcch-ConfigSIB1 may provide information on a frequency position at which SSB/SIB1 is present and a frequency range in which the SSB/SIB1 is not present.

The SIB1 may include information related to the availability and scheduling (e.g., a transmission period and an SI-window size) of the remaining SIBs (hereinafter an SIBx, x being an integer equal to or greater than 2). For example, the SIB1 may inform whether SIBx is periodically broadcast or is provided in response to a request of the UE using an on-demand method. When the SIBx is provided using the on-demand method, the SIB1 may include information required to make a request for the SI by the UE. The SIB1 may be transmitted through a PDSCH, a PDCCH for scheduling the SIB1 may be transmitted through the Type0-PDCCH common search space, and the SIB1 may be transmitted through a PDSCH indicated by the PDCCH.

The SIBx may be included in an SI message and may be transmitted through a PDSCH. Each SI message may be transmitted within a window (i.e., an SI-window) that is periodically generated.

### 1.5. Wireless Communication System for Supporting Unlicensed Band/Shared Spectrum

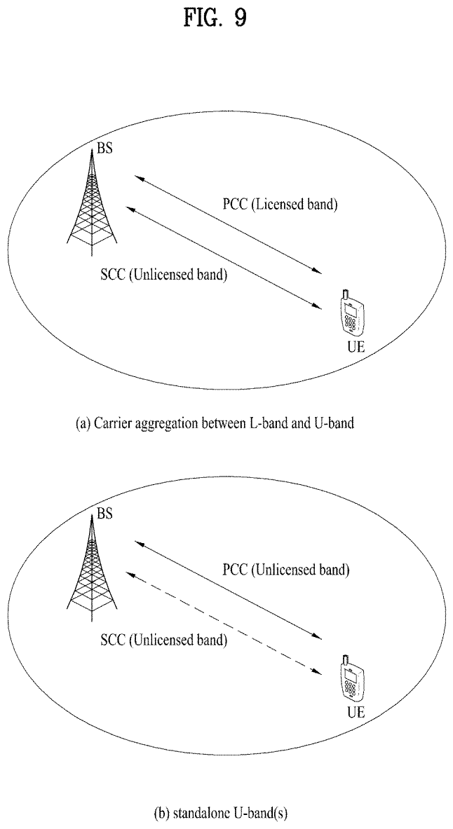

FIG. 9 is a diagram showing an example of a wireless communication system for supporting an unlicensed band to which various embodiments of the present disclosure are applicable.

For example, FIG. 9 may include an NR-unlicensed spectrum (NR-U) wireless communication system.

In the following description, a cell operating in a licensed band (hereinafter an L-band) may be defined as an LCell and a carrier of the LCell may be defined as a (DL/UL) LCC. A cell operating in an unlicensed band (hereinafter a U-band) may be defined as a UCell and a carrier of the UCell may be defined as a (DL/UL) UCC. A carrier/carrier-frequency of a cell may refer to an operation frequency (e.g., a center frequency) of the cell. The cell/carrier (e.g., CC) may be collectively referred to as a cell.

As shown in FIG. 9(a), when a UE and a BS transmit and receive signals through a LCC and a UCC that are carrier-coupled to each other, the LCC may be set to a primary CC (PCC) and the UCC may be set to a secondary CC (SCC). As shown in FIG. 9(b), the UE and the BS may transmit and receive signals through one UCC or a plurality of UCCs that are carrier-coupled to each other. That is, the UE and the BS may transmit and receive signals through only UCC(s) without an LCC. For a standalone operation, transmission of a PRACH, a PUCCH, a PUSCH, and an SRS, and so on may be supported in the UCell.

Hereinafter, a signal transmission and reception operation in an unlicensed band described in the description of various embodiments of the present disclosure may be performed based on the aforementioned deployment scenario (unless otherwise stated).

Unless otherwise stated, the following definitions may be applied to terms used in the description of various embodiments of the present disclosure (in relation to the unlicensed band).

Channel: This may include consecutive RBs in which a channel access procedure is performed in a shared spectrum and may refer to a carrier or a portion of the carrier.

Channel access procedure (CAP): This may refer to a procedure of evaluating channel availability based on sensing in order to determine whether other communication node(s) use a channel before transmitting signals. A basic unit for sensing may be a sensing slot of a duration of Tₛₗ=9 us. The BS or the UE may sense the channel during a sensing slot duration, and when power detected for at least 4 us within a sensing slot duration is less than energy detection threshold XThresh, the sensing slot duration Tₛₗ may be considered to be an idle state. Otherwise, the sensing slot duration Tₛₗ=9 us may be considered to be a busy state. The CAP may be referred to as Listen-Before-Talk (LBT).

Channel Occupancy: This may refer to corresponding transmission(s) on channel(s) by the BS/UE after the channel access procedure.

Channel Occupancy Time (COT): This may refer to a total time for performing transmission(s) on the channel by the BS/UE and any BS/UE(s) that share channel occupancy after the BS/UE performs the channel access procedure. When the COT is determined, if a transmission gap is equal to or less than 25 us, a gap duration may also be counted in the COT. The COT may be shared for transmission between the BS and corresponding UE(s).

DL transmission burst: This may be defined as a transmission set from a BS without a gap greater than 16 micro-seconds (us). Transmissions from the BS, which are separated by a gap greater than 16 us, may be considered to be separate DL transmission bursts. The BS may perform transmission(s) after the gap rather than sensing channel availability within the DL transmission burst.

UL transmission burst: This may be defined as a transmission set from a UE without a gap greater than 16 us. Transmissions from the UE, which are separated by a gap greater than 16 us, may be considered to be separate UL transmission bursts. The UE may perform transmission(s) after the gap rather than sensing channel availability within the UL transmission burst.

Discovery burst: This may refer to a DL transmission burst including a set of signal(s) and/or channel(s), which are limited within a (time) window and are related to a duty cycle. In an LTE-based system, the discovery burst may refer to transmission(s) initiated by a BS, may include a PSS, a SSS, and a cell-specific RS (CRS), and may further include a non-zero power CSI-RS. In an NR-based system, the discovery burst may refer to transmission(s) initiated by a BS, may include at least a SS/PBCH block, and may further include a CORESET for a PDCCH for scheduling a PDSCH having SIB1, a PDSCH for carrying the SIB1, and/or the non-zero power CSI-RS.

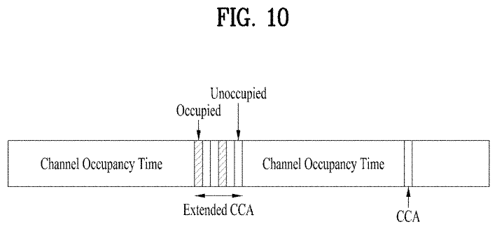

FIG. 10 is a diagram showing an example of a method of occupying a resource within an unlicensed band to which various embodiments of the present disclosure are applicable.

Referring to FIG. 10, a communication node (e.g., a BS and a UE) within the unlicensed band needs to determine whether other communication node(s) use a channel before transmitting signals. To this end, the communication node within the unlicensed band may perform a channel access procedure (CAP) in order to access channel(s) in which transmission(s) is performed. The channel access procedure may be performed based on sensing. For example, the communication node may check whether other communication node(s) transmit signals by performing carrier sensing (CS) before transmitting signals. When it is determined that other communication node(s) do not transmit signals, it may be defined that Clear Channel Assessment (CCA) is checked. When there is a CCA threshold (e.g., XThresh) that is predefined or configured by a higher layer (e.g., RRC), the communication node may determine a channel state to be busy when detecting higher energy than the CCA threshold from the channel, and otherwise, the communication node may determine the channel state to be idle. When determining the channel state to be idle, the communication node may start signal transmission in the unlicensed band. The CAP may be replaced with LBT.

Table 10 below shows a channel access procedure (CAP) supported in the NR-U.

TABLE 10

| | Type | Explanation |
|---|---|---|
| DL | Type 1 CAP | CAP with random back-off |
| | | time duration spanned by the sensing slots that |
| | | are sensed to be idle before a downlink |
| | | transmission(s) is random |
| | Type 2 CAP | CAP without random back-off |
| | Type 2A, 2B, 2C | time duration spanned by sensing slots that are |
| | | sensed to be idle before a downlink |
| | | transmission(s) is deterministic |
| UL | Type 1 CAP | CAP with random back-off |
| | | time duration spanned by the sensing slots that |
| | | are sensed to be idle before a downlink |
| | | transmission(s) is random |
| | Type 2 CAP | CAP without random back-off |
| | Type 2A, 2B, 2C | time duration spanned by sensing slots that are |
| | | sensed to be idle before a downlink |
| | | transmission(s) is deterministic |

LBT-SubBand (SB) (or a RB Set)

One cell (or a carrier (e.g., CC)) or a BWP configured for a UE may be configured with a wideband having a larger BandWidth (BW) compared with the existing LTE in a wireless communication system that supports an unlicensed band. However, a BW required by CCA based on an independent LBT operation may be limited based on the regulation or the like. When a sub-band (SB) in which separate LBT is performed is defined as an LBT-SB, one wideband cell/BWP may include a plurality of LBT-SBs. An RB set included in the LBT-SB may be configured via higher-layer (e.g., RRC) signaling. Thus, one cell/BWP may include one or more LBT-SBs based on (i) a BW of a cell/BWP and (ii) RB set allocation information.

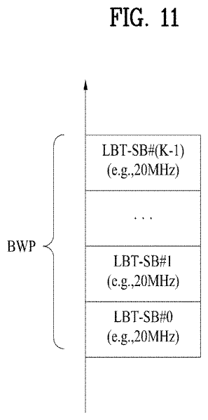

FIG. 11 is a diagram showing an example of the case in which a plurality of LBT-SBs is included in an unlicensed band to which various embodiments of the present disclosure are applicable.

Referring to FIG. 11, a BWP of a cell (or a carrier) may include a plurality of LBT-SBs. The LBT-SB may have, for example, a band of 20 MHz. The LBT-SB may include a plurality of consecutive (P)RBs in the frequency domain and may be referred to as a (P)RB set. Although not shown, a guard band (GB) may be contained between LBT-SBs. Thus, the BWP may be configured in the form of {LBT-SB #0 (RB set #0)+GB #0+LBT-SB #1 (RB set #1+GB #1)+ . . . +LBT-SB #(K−1) (RB set (#K−1))}. For convenience, an LBT-SB/RB index may be configured/defined to increase toward a high frequency band from a low frequency band.

Downlink Signal Transmission Method Through Unlicensed Band

A BS may perform one channel access procedure (CAP) of the following methods for DL signal transmission in an unlicensed band.

(1) Type 1 DL CAP Method

The length of a time duration spanned by a sensing slot that is sensed to be idle before transmission(s) in Type 1 DL CAP may be random. Type 1 DL CAP may be applied to the following transmission.

Transmission(s) initiated by a BS, including (i) a unicast PDSCH having user plane data, or (ii) a unicast PDSCH having user plane data and a unicast PDCCH for scheduling user plane data, or,

Transmission(s) initiated by a BS, having i) a discovery burst only, or (ii) non-unicast information and a multiplexed discovery burst.

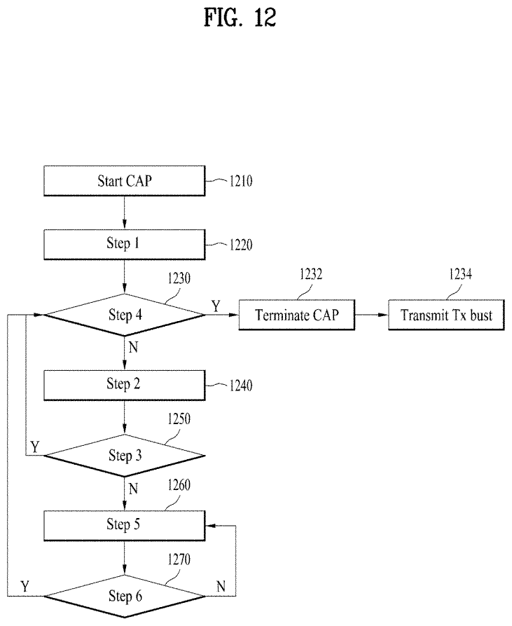

FIG. 12 is a flowchart of a CAP operation for DL signal transmission through an unlicensed band to which various embodiments of the present disclosure are applicable.

Referring to FIG. 12, for DL transmission, a transmission node (e.g., a BS) may initiate a channel access procedure (CAP) (1210).

A BS may sense a channel to be in an idle state for a sensing slot duration of a defer duration T_{d}, and then when a counter N is 0, the BS may perform transmission (1234). In this case, the counter N may be adjusted by sensing a channel during additional sensing slot duration(s) according to the following procedure:

Step 1) (1220) N=Nᵢₙᵢₜ may be set. Here, Nᵢₙᵢₜ may be a random value that is evenly distributed between 0 and CWₚ. Then, the procedure may proceed to Step 4.

Step 2) (1240) When N>0 and a BS selects to reduce the counter, N=N−1 may be set.

Step 3) (1250) A channel may be sensed during an additional sensing slot duration. In this case, when the additional sensing slot duration is idle (Y), the procedure may proceed to Step 4. Otherwise (N), the procedure may proceed to Step 5.

Step 4) (1230) When N=0 (Y), the CAP procedure may be terminated (1232). Otherwise (N), the procedure may proceed to Step 2.

Step 5) (1260) A channel may be sensed until a busy sensing slot is detected within an additional defer duration T_{d} or all sensing slots within the additional defer duration T_{d} are detected to be idle.

Step 6) (1270) When a channel is sensed to be idle during all sensing slot durations of the additional defer duration T_{d} (Y), the procedure may proceed to Step 4. Otherwise (N), the procedure may proceed to Step 5.

As seen from Table 11, mₚ, Minimum Contention Window (CW), Maximum CW, Maximum Channel Occupancy Time (MCOT), and allowed CW sizes, which are applied to the CAP, may be changed according to a channel access priority class.

TABLE 11

| Channel Access | | | | | |
|---|---|---|---|---|---|
| Priority Class | | | | | |
| (p) | mₚ | CW_{min,p} | CW_{max,p} | T_{mcot,p} | allowed CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, |
| | | | | | 255, 511, 1023} |

The defer duration T_{d} may be configured with duration T_{f} (16 us)+mp consecutive sensing slot durations Tₛₗ (9us) in the stated order. T_{f} may include a sensing slot duration Tₛₗ at a starting point of a duration of 16 us.

CW_{min,p}<=CWₚ <=CW_{max,p}. CWₚ may be set to CWₚ=CW_{min,p} and may be updated prior to Step 1 based on HARQ-ACK feedback (e.g., an ACK or NACK ratio) for a previous DL burst (e.g., a PDSCH) (CW size update). For example, CWₚ may be initialized to CW_{min,p}, may be increased to a next highest allowed value, or may be maintained as an original value, based on HARQ-ACK feedback for a previous DL burst.

(2) Type 2 DL CAP Method

The length of a time duration spanned by a sensing slot that is sensed to be idle before transmission (s) in Type 2 DL CAP may be deterministic. Type 2 DL CAP may be classified into Type 2A/2B/2C DL CAP.

Type 2A DL CAP may be applied to the following transmission. In Type 2A DL CAP, a BS may perform transmission immediately after a channel is sensed to be idle during at least a sensing duration T_{short_dl}=25 us. Here, T_{short_dl} may include a duration T_{f}(=16 us) and one sensing slot duration immediately following the same. T_{f} may include a sensing slot at a starting point of a duration.

(i) Transmission(s) initiated by a BS, having i) a discovery burst only, or (ii) non-unicast information and a multiplexed discovery burst, or

Transmission(s) of a BS after a gap of 25 us from transmission (s) by a UE within shared channel occupancy.

Type 2B DL CAP may be applicable to transmission(s) by a BS after a gap of 16 us from transmission (s) by a UE within a Shared Channel Occupancy Time. In Type 2B DL CAP, the BS may perform transmission immediately after a channel is sensed to be idle during T_{f}=16 us. T_{f} may include a sensing slot within 9 us from the last of a duration. Type 2C DL CAP may be applicable to transmission(s) performed by a UE after the maximum gap of 16 us from transmission(s) by a UE within the Shared Channel Occupancy Time. In Type 2C DL CAP, a BS may not sense a channel before transmission.

UL Signal Transmission Method through Unlicensed Band

A UE may perform Type 1 or Type 2 CAP for UL signal transmission in an unlicensed band. In general, the UE may perform CAP (e.g., Type 1 or Type 2) configured by a BS for UL signal transmission. For example, information of CAP type of the UE may be included within UL grant (e.g., DCI format 0_0, 0_1) for scheduling PUSCH transmission.

(1) Type 1 UL CAP Method

The length of a time duration spanned by a sensing slot that is sensed to be idle before transmission(s) in Type 1 1 UL CAP may be random. Type 1 UL CAP may be applied to the following transmission.

PUSCH/SRS transmission(s) scheduled and/or configured from a BS

PUCCH transmission(s) scheduled and/or configured from a BS

Transmission(s) related to Random Access Procedure (RAP)

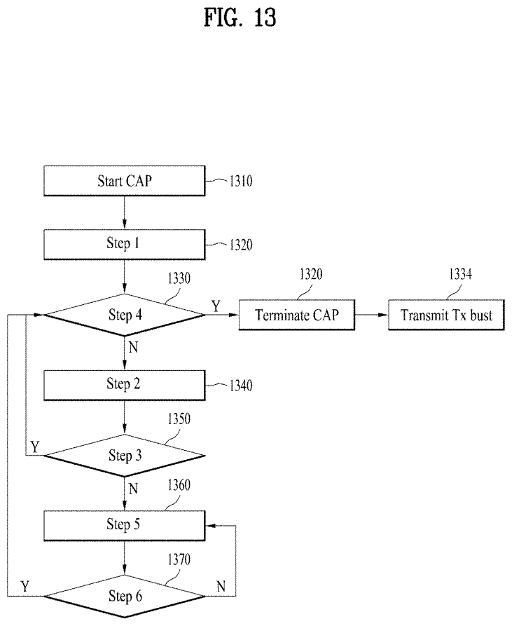

FIG. 13 is a flowchart of a CAP operation for UL signal transmission through an unlicensed band to which various embodiments of the present disclosure are applicable.

Referring to FIG. 13, for UL transmission, a transmission node (e.g., a UE) may initiate a channel access procedure (CAP) in order to operate in an unlicensed band (1310).

A UE may sense a channel to be in an idle state for a sensing slot duration of a defer duration T_{d}, and then when a counter N is 0, the UE may perform transmission (1334). In this case, the counter N may be adjusted by sensing a channel during additional sensing slot duration(s) according to the following procedure:

Step 1) (1320) N=Nᵢₙᵢₜ may be set. Here, Nᵢₙᵢₜ may be a random value that is evenly distributed between 0 and CWₚ. Then, the procedure may proceed to Step 4.

Step 2) (1340) When N>0and aUE selects to reduce the counter, N=N−1 may be set.

Step 3) (1350) A channel may be sensed during an additional sensing slot duration. In this case, when the additional sensing slot duration is idle (Y), the procedure may proceed to Step 4. Otherwise (N), the procedure may proceed to Step 5.

Step 4) (1330) When N=0 (Y), the CAP procedure may be terminated (S1532). Otherwise (N), the procedure may proceed to Step 2.

Step 5) (1360) A channel may be sensed until a busy sensing slot is detected within an additional defer duration T_{d} or all sensing slots within the additional defer duration T_{d} are detected to be idle.

Step 6) (1370) When a channel is sensed to be idle during all sensing slot durations of the additional defer duration T_{d} (Y), the procedure may proceed to Step 4. Otherwise (N), the procedure may proceed to Step 5.

As seen from Table 12, mₚ, Minimum CW, Maximum CW, Maximum Channel Occupancy Time (MCOT), and allowed CW sizes, which are applied to the CAP, may be changed according to a channel access priority class.

TABLE 12

| Channel Access | | | | | |
|---|---|---|---|---|---|
| Priority Class | | | | | |
| (p) | mₚ | CW_{min,p} | CW_{max,p} | T_{slmcot,p} | allowed CWₚ sizes |
| 1 | 2 | 3 | 7 | 2 ms | {3, 7} |
| 3 | 2 | 7 | 15 | 4 ms | {7, 15} |
| 3 | 3 | 15 | 1023 | 6 or 10 ms | {15, 31, 63, 127, |
| | | | | | 255, 511, 1023} |
| 4 | 7 | 15 | 1023 | 6 or 10 ms | {15, 31, 63, 127, |
| | | | | | 255, 511, 1023} |

The defer duration T_{d} may be configured with a duration T_{f} (16 us)+mp consecutive sensing slot durations Tₛₗ (9 us) in the stated order. T_{f} may include a sensing slot duration Tₛₗ at a starting point of a duration of 16 us.

CW_{min,p}<=CWₚ<=CW_{max,p}. CWₚ may be set to CWₚ=CW_{min,p} and may be updated prior to Step 1 based on explicit/implicit reception response to a previous UL burst (e.g., a PUSCH) (CW size update). For example, CWₚ may be initialized to CW_{min,p}, may be increased to a next highest allowed value, or may be maintained as an original value, based on explicit/implicit reception response to a previous UL burst.

(2) Type 2 UL CAP Method

The length of a time duration spanned by a sensing slot that is sensed to be idle before transmission (s) in Type 2 UL CAP may be deterministic. Type 2 UL CAP may be classified into Type 2A/2B/2C UL CAP. In Type 2A UL CAP, a UE may perform transmission immediately after a channel is sensed to be idle during at least a sensing duration T_{short_dl}=25 us. Here, T_{short_dl} may include a duration T_{f}(=16 us) and one sensing slot duration immediately following the same. In Type 2A UL CAP, T_{f} may include a sensing slot at a starting point of a duration. In Type 2B UL CAP, the UE may perform transmission immediately after a channel is sensed to be idle during a sensing duration T_{f}=16 us. In Type 2B UL CAP, T_{f} may include a sensing slot within 9 us from the last of a duration. In Type 2C UL CAP, a UE may not sense a channel before transmission.

### 2. Random Access (RACH) Procedure

When a UE initially accesses a BS or has no radio resources for a signal transmission, the UE may perform a random access procedure with the BS.

The random access procedure is used for various purposes. For example, the random access procedure may be used for initial network access in an RRC_IDLE state, an RRC connection reestablishment procedure, handover, UE-triggered UL data transmission, transition in an RRC_INACTIVE state, time alignment establishment in SCell addition, OSI request, and beam failure recovery. The UE may acquire UL synchronization and UL transmission resources in the random access procedure.

Random access procedures may be classified into a contention-based random access procedure and a contention-free random access procedure. The contention-based random access procedure is further branched into a 4-step random access (4-step RACH) procedure and a 2-step random access (2-step RACH) procedure.

### 2.1. 4-step RACH: Type-1 Random Access Procedure

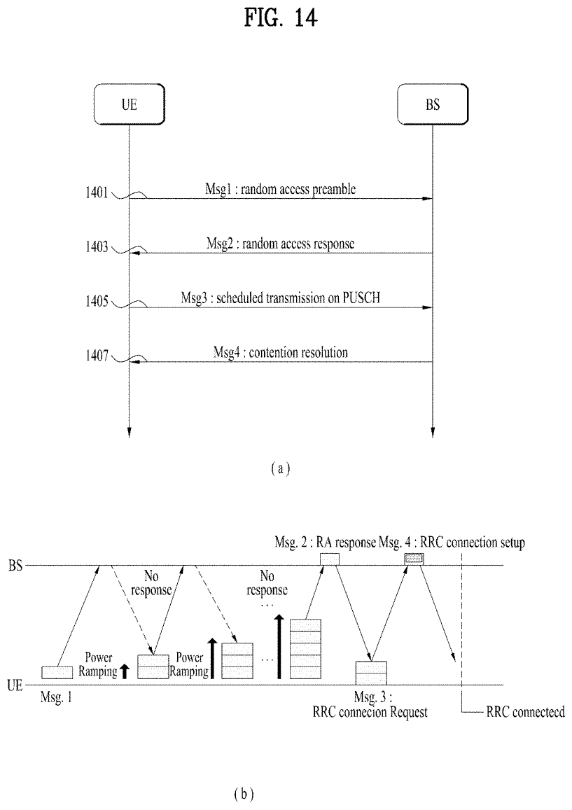

FIG. 14 is a diagram illustrating an exemplary 4-step RACH procedure to which various embodiments of the present disclosure are applicable.

When the (contention-based) random access procedure is performed in four steps (4-step RACH procedure), the UE may transmit a message (Message 1 (Msg1)) including a preamble related to a specific sequence on a PRACH (1401) and receive a PDCCH and a response message (RAR message) (Message 2 (Msg2)) for the preamble on a PDSCH corresponding to the PDCCH (1403). The UE transmits a message (Message 3 (Msg3)) including a PUSCH based on scheduling information included in the RAR (1405) and perform a contention resolution procedure involving reception of a PDCCH signal and a PDSCH signal corresponding to the PDCCH signal. The UE may receive a message (Message 4 (Msg4)) including contention resolution information for the contention resolution procedure from the BS (1707).

The 4-step RACH procedure of the UE may be summarized in Table 13 below.

TABLE 13

| | Type of Signals | Operations/Information obtained |
|---|---|---|
| 1^{st} step | PRACH preamble in UL | Initial beam obtainment |
| | | Random selection of RA- |
| | | preamble ID |
| 2^{nd} step | Random Access Response | Timing Advanced |
| | on DL-SCH | information |
| | | RA-preamble ID |
| | | Initial UL grant. Temporary |
| | | C-RNTI |
| 3^{rd} step | UL transmission on | RRC connection request |
| | UL-SCH | UE identifier |
| 4^{th} step | Contention Resolution | Temporary C-RNTI on PDCCH |
| | on DL | for initial access C-RNTI on |
| | | PDCCH for UE in RRC |
| | | CONNECTED |

In the random access procedure, the UE may first transmit an RACH preamble as Msg1 on a PRACH.

Random access preamble sequences of two different lengths are supported. The longer sequence length 839 is applied to the SCSs of 1.25 kHz and 5 kHz, whereas the shorter sequence length 139 is applied to the SCSs of 15 kHz, 30 kHz, 60 kHz, and 120 kHz.

Multiple preamble formats are defined by one or more RACH OFDM symbols and different CPs (and/or guard times). An RACH configuration for a cell is provided in system information of the cell to the UE. The RACH configuration includes information about a PRACH SCS, available preambles, and a preamble format. The RACH configuration includes information about associations between SSBs and RACH (time-frequency) resources. The UE transmits a RACH preamble in RACH time-frequency resources associated with a detected or selected SSB.

An SSB threshold for RACH resource association may be configured by the network, and an RACH preamble is transmitted or retransmitted based on an SSB having a reference signal received power (RSRP) measurement satisfying the threshold. For example, the UE may select one of SSBs satisfying the threshold, and transmit or retransmit the RACH preamble in an RACH resource associated with the selected SSB. For example, when retransmitting the RACH preamble, the UE may reselect one of the SSBs and retransmit the RACH preamble in an RACH resource associated with the reselected SSB. That is, the RACH resource for the retransmission of the RACH preamble may be identical to and/or different from the RACH resource for the transmission of the RACH preamble.

Upon receipt of the RACH preamble from the UE, the BS transmits an RAR message (Msg2) to the UE. A PDCCH that schedules a PDSCH carrying the RAR is cyclic redundancy check (CRC)-masked by a random access radio network temporary identifier (RA-RNTI) and transmitted. Upon detection of the PDCCH masked by the RA-RNTI, the UE may receive the RAR on the PDSCH scheduled by DCI carried on the PDCCH. The UE determines whether the RAR includes RAR information for its transmitted preamble, that is, Msg1. The UE may make the determination by checking the presence or absence of the RACH preamble ID of its transmitted preamble in the RAR. In the absence of the response to Msg1, the UE may retransmit the RACH preamble a predetermined number of or fewer times, while performing power ramping. The UE calculates PRACH transmission power for the preamble retransmission based on the latest pathloss and a power ramping counter.

The RAR information may include a preamble sequence transmitted by the UE, a temporary cell RNTI (TC-RNTI) that the BS has allocated to the UE attempting random access, UL transmit time alignment information, UL transmission power adjustment information, and UL radio resource allocation information. Upon receipt of its RAR information on a PDSCH, the UE may acquire time advance information for UL synchronization, an initial UL grant, and a TC-RNTI. The timing advance information is used to control a UL signal transmission timing. For better alignment between a PUSCH/PUCCH transmission of the UE and a subframe timing of a network end, the network (e.g., the BS) may measure the time difference between a PUSCH/PUCCH/SRS reception and a subframe and transmit the timing advance information based on the time difference. The UE may transmit a UL signal as Msg3 of the random access procedure on a UL-SCH based on the RAR information. Msg3 may include an RRC connection request and a UE ID. The network may transmit Msg4 in response to Msg3. Msg4 may be treated as a contention resolution message on DL. As the UE receives Msg4, the UE may enter an RRC_CONNECTED state.

As described before, the UL grant included in the RAR schedules a PUSCH transmission to the BS. A PUSCH carrying an initial UL transmission based on the UL grant of the RAR is referred to as an Msg3 PUSCH. The content of the RAR UL grant starts from the most significant bit (MSB) and ends in the least significant bit (LSB), given as Table 14.

TABLE 14

| | Number of |
|---|---|
| RAR UL grant field | bits |
| Frequency hopping flag | 1 |
| Msg3 PUSCH frequency resource | 12 |
| al location | |
| Msg3 PUSCH time resource allocation | 4 |
| Modulation and coding scheme (MCS) | 4 |
| Transmit power control (TPC) for | 3 |
| Msg3 PUSCH | |
| CSI request | 1 |

A transmit power control (TPC) command is used to determine the transmission power of the Msg3 PUSCH. For example, the TPC command is interpreted according to Table 15.

TABLE 15

| TPC command | value [dB] |
|---|---|
| 0 | −6 |
| 1 | −4 |
| 2 | −9 |
| 3 | 0 |
| 4 | 2 |
| 5 | 4 |
| 6 | 6 |
| 7 | 8 |

### 2.2. 2-step RACH: Type-2 Random Access Procedure

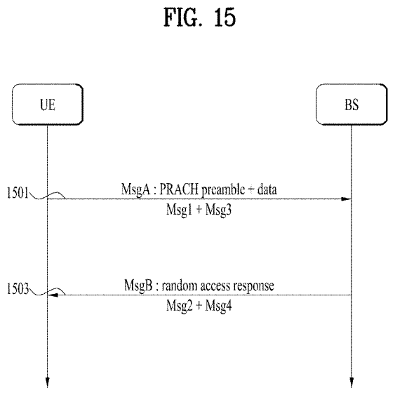

FIG. 15 is a diagram illustrating an exemplary 2-step RACH procedure to which various embodiments of the present disclosure are applicable.

The (contention-based) RACH procedure performed in two steps, that is, the 2-step RACH procedure has been proposed to simplify the RACH procedure and thus achieve low signaling overhead and low latency.

In the 2-step RACH procedure, the operation of transmitting Msg1 and the operation of transmitting Msg3 in the 4-step RACH procedure may be incorporated into an operation of transmitting one message, Message A (MsgA) including a PRACH and a PUSCH by the UE. The operation of transmitting Msg2 by the BS and the operation of transmitting Msg4 by the BS in the 4-step RACH procedure may be incorporated into an operation of transmitting one message, Message B (MsgB) including an RAR and contention resolution information.

That is, in the 2-step RACH procedure, the UE may combine Msg1 and Msg3 of the 4-step RACH procedure into one message (e.g., MsgA) and transmit the message to the BS (1501).

Further, in the 2-step RACH procedure, the BS may combine Msg2 and Msg4 of the 4-step RACH procedure into one message (e.g., MsgB) and transmit the message to the UE (1503).

The 2-step RACH procedure may become a low-latency RACH procedure based on the combinations of these messages.

More specifically, MsgA may carry a PRACH preamble included in Msg1 and data included in Msg3 in the 2-step RACH procedure. In the 2-step RACH procedure, MsgB may carry an RAR included in Msg2 and contention resolution information included in Msg4.

### 2.3. Contention-Free RACH

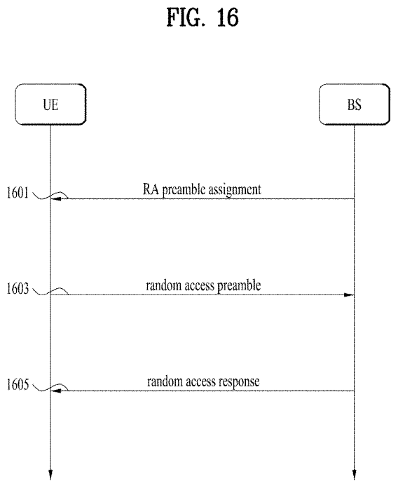

FIG. 16 is a diagram illustrating an exemplary contention-free RACH procedure to which various embodiments of the present disclosure are applicable.

The contention-free RACH procedure may be used for handover of the UE to another cell or BS or may be performed when requested by a BS command. The contention-free RACH procedure is basically similar to the contention-based RACH procedure. However, compared to the contention-based RACH procedure in which a preamble to be used is randomly selected from among a plurality of RACH preambles, a preamble to be used by the UE (referred to as a dedicated RACH preamble) is assigned to the UE by the BS in the contention-free RACH procedure (1601). Information about the dedicated RACH preamble may be included in an RRC message (e.g., a handover command) or provided to the UE by a PDCCH order. When the RACH procedure starts, the UE transmits the dedicated RACH preamble to the BS (1603). When the UE receives an RAR from the BS, the RACH procedure is completed (1605).

In the contention-free RACH procedure, a CSI request field in an RAR UL grant indicates whether the UE is to include an aperiodic CSI report in a corresponding PUSCH transmission. An SCS for the Msg3 PUSCH transmission is provided by an RRC parameter. The UE may transmit the PRACH and the Msg3 PUSCH in the same UL carrier of the same serving cell. A UL BWP for the Msg3 PUSCH transmission is indicated by SIB 1.

### 2.4. Mapping between SSB Blocks and PRACH Resource (Occasion)

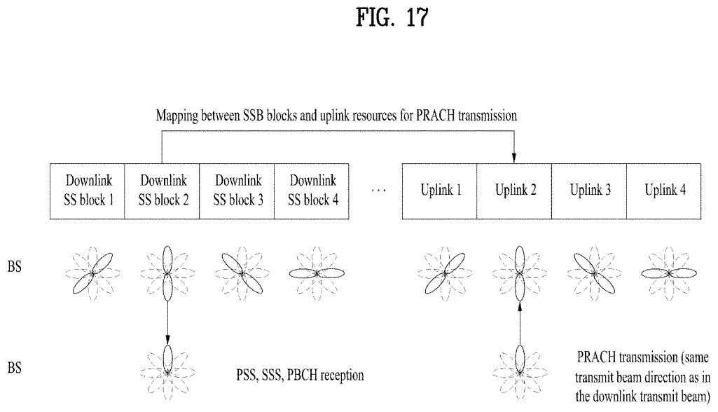

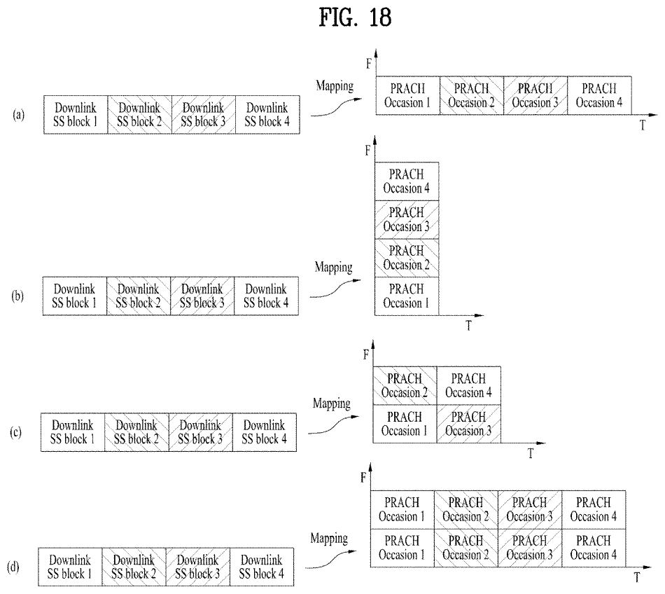

FIGS. 17 and 18 are diagrams showing an example of transmission of an SS block and a PRACH resource linked to the SS block according to various embodiments of the present disclosure.

In order for a BS to communicate with one UE, an optimum beam direction between the BS and the UE needs to be found, and as the UE moves, the optimum beam direction may be changed, and thus the optimum beam direction needs to be continuously tracked. A procedure of finding the optimum beam direction between a BS and a UE may be referred to as a beam acquisition procedure, and a procedure of continuously tracking the optimum beam direction may be referred to as a beam tracking procedure. The procedure may be required for a state in which the optimum beam is lost and communication with the BS is not capable of being maintained in an optimum communication state or enters a state in which communication is impossible, that is, beam recovery for recovering beam failure during 1) initial access in which the UE attempts first access to the BS, 2) handover from one BS to another BS, and 3) beam tracking of finding an optimum beam between the UE and the BS.

A multi-step beam acquisition procedure is being discussed for beam acquisition in an environment using multiple beams in the case of the NR system. In the multi-step beam acquisition procedure, the BS and the UE may perform connection setup using a wide beam in an initial access stage, and after the connection setup is completed, the BS and the UE may perform communication with the optimum quality using a narrow beam. An example of the beam acquisition procedure in an NR system to which various embodiments of the present disclosure will be described below.

1) The BS may transmit a synchronization block for each wide bam in order for the UE to find a BS in an initial access stage, that is, to perform cell search or cell acquisition, to measure the quality for a channel for each beam of a wide beam, and to find an optimum wide beam to be used in a primary stage of beam acquisition.

2) The UE may perform cell search on a synchronization block for each beam and may perform DL beam acquisition using a detection result for each beam.

3) The UE may perform an RACH procedure in order to inform that the UE intends to access a BS that the UE finds.

4) In order for the UE to notify the BS of the DL beam acquisition result (e.g., a beam index) at a wide beam level simultaneously with the RACH procedure, the BS may connect or relate a synchronization block transmitted for each beam and a PRACH resource to be used for PRACH transmission. When the UE performs the RACH procedure using the PRACH resource connected to the optimum beam direction that the UE finds, the BS may acquire information on a DL beam appropriate for the UE during a procedure of receiving a PRACH preamble.

In a multi-beam environment, it may be important to accurately determine a Tx beam and/or a Rx beam direction between the UE and a transmission and reception point (TRP) by the UE and/or the TRP. In the multi-beam environment, beam sweeping for repeatedly transmitting a signal or receiving a signal depending on TX/RX reciprocal capability of the TRP (e.g., a BS) or a UE may be considered. The TX/RX reciprocal capability may be referred to as TX/RX beam correspondence in the TRP and the UE. In the multi-beam environment, when the TX/RX reciprocal capability in the TRP and the UE is not held, the UE may shoot a UL signal in a beam direction in which the UE receives a DL signal. This is because an optimum path of UL and an optimum path of DL are different. The TX/RX beam correspondence in the TRP may be held when the TRP determines a TRP RX beam for corresponding UL reception based on DL measurement of the UE with respect to one or more TX beams of the TRP and/or the TRP determines a TRP TX beam for corresponding DL transmission based on UL measurement of TRP' with respect to one or more RX beams of the TRP. The TX/RX beam correspondence in the UE may be held when the UE determines a UE RX beam for corresponding UL transmission based on DL measurement of the UE with respect to one or more RX beams of the UE and/or the UE determines a UE RX beam for corresponding DL reception based on indication of the TRP based on UL measurement with respect to one or more TX beams of the UE.

### 2.5. PRACH Preamble Structure

In an NR system, an RACH signal used for initial access to a BS, that is, initial access to the BS through a cell used by the BS may be configured using the following factors.

Cyclic prefix (CP): This may prevent interface from a previous/forward (OFDM) symbol and may bundle PRACH preamble signals reaching a BS with various time delays in the same time zone. That is, when the CP is set to be appropriate for the maximum cell radius, PRACH preambles transmitted in the same resource by UEs in the cell may enter a PRACH reception window corresponding to the length of a PRACH preamble set by the BS for PRACH reception. The length of the CP may be generally set to be equal to or greater than the maximum round trip delay. The CP may have a length T_{CP}.

Preamble (sequence): A sequence for detecting transmission of a signal by a BS may be defined, and a preamble may carry the sequence. The preamble sequence may have a length T_{SEQ}.

Guard time (GT): This may be a duration defined to prevent a PRACH signal that is transmitted from the farthest to the BS in PRACH coverage and arrives at the BS with delay from interfering with a signal arriving at the BS after a PRACH symbol duration, and the UE does not transmit a signal during the duration, and thus the GT may not be defined based on the PRACH signal. The GT may have a length T_{GP}.

### 2.6. Mapping to Physical Resources for Physical Random-Access Channel

A random-access preamble may be transmitted within only a time resource acquired based on a RACH configuration table that is preconfigured for RACH configuration, FR1, FR2, and a preconfigured spectrum type.

A PRACH configuration index in the RACH configuration table may be given as follows.

For a RACH configuration table for Random access configurations for FR1 and an unpaired spectrum, the PRACH configuration index in the RACH configuration table may be given from a higher layer parameter prach-ConfigurationIndexNew (if configured). Otherwise, the PRACH configuration index in the RACH configuration table may be given from prach-ConfigurationIndex, msgA-prach-ConfigurationIndex, msgA-prach-ConfigurationIndexNew (if configured), or the like.

The PRACH configuration index in the RACH configuration table may be given from higher layer parameter prach-ConfigurationIndex, msgA-prach-ConfigurationIndexNew (if configured), or the like for a RACH configuration table about Random access configurations for FR1 and paired spectrum/supplementary uplink and a RACH configuration table about Random access configurations for FR2 and unpaired spectrum.

The RACH configuration table may be a table about a relationship between one or more of a PRACH configuration Index, a Preamble format, n_{SFN} mod x=y, a Subframe number, a Starting symbol, the Number of PRACH slots, the number of time-domain PRACH occasions within a PRACH slot, and a PRACH duration in cases.

The cases will be described below:

(1) Random access configurations for FR1 and paired spectrum/supplementary uplink

(2) Random access configurations for FR1 and unpaired spectrum

(3) Random access configurations for FR2 and unpaired spectrum

Table 16 below shows a portion of an example of a RACH configuration index for (2) Random access configurations for FR1 and unpaired spectrum.

TABLE 16

| | | | | | | | N [symbol] | |
|---|---|---|---|---|---|---|---|---|
| | | | | | | | number of | |
| | | | | | | | time [symbol] | |
| | | | | | | Number | domain | |
| | | | | | | of | PRACH | |
| | | | | | | PRACH | occasions | |
| PRACH | | | | | | slots | within a | N [symbol] |
| Configuration | Preamble | n_{SFN} modx = y | | | Starting | within a | PRACH | PRACH |
| Index | format | x | y | Subframe number | symbol | subframe | slot | duration |
| 0 | 0 | 10 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |

[symbol]

indicates data missing or illegible when filed

### 3. Various Embodiments of the Present Disclosure

A detailed description will be given of various embodiments of the present disclosure based on the above technical ideas. The afore-described contents of clause 1 and clause 2 are applicable to various embodiments of the present disclosure described below. For example, operations, functions, terminologies, and so on which are not defined in various embodiments of the present disclosure may be performed and described based on clause 1 and clause 2.

Symbols/abbreviations/terms used in the description of various embodiments of the present disclosure may be defined as follows.

A/B/C: A and/or B and/or C

DL: downlink

OFDM: orthogonal frequency division multiplexing

PRACH: physical random access channel

PUSCH: physical uplink shared channel

RA: random access

RACH: random access channel

RO: RACH occasion or PRACH occasion

SC: subcarrier

SCS: subcarrier spacing

SSB synchronization signal block

SS/PBCH: synchronization signal/physical broadcast channel

UL: uplink

In the description according to various embodiments of the present disclosure, the term “greater than/above A” may be replaced by the term “above/greater than A”.

In the description according to various embodiments of the present disclosure, the term “less than/below B” may be replaced by the term “below/less than B”.

Table 17 shows a portion of an example of an RACH configuration table representing RACH configuration for FR1 and an unpaired spectrum of a 3GPP NR system.

TABLE 17

| | | | | | | | | OFDM |
|---|---|---|---|---|---|---|---|---|
| | | | SFN | | Starting | | Number | symbols |
| | RACH | Periodicity | offset | Subframe | OFDM | Number | of | for RACH |
| Index | Format | (x) | (y) | index | symbol | of slots | occasions | format |
| 67 | A1 | 16 | 1 | 9 | 0 | 2 | 6 | 2 |
| 68 | A1 | 8 | 1 | 9 | 0 | 7 | 6 | 2 |
| 69 | A1 | 4 | 1 | 9 | 0 | 1 | 6 | 2 |
| 70 | A1 | 2 | 1 | 9 | 0 | 1 | 6 | 2 |
| 71 | A1 | 2 | 1 | 4.9 | 7 | 1 | 6 | 2 |
| 75 | A1 | 2 | 1 | 4.9 | 0 | 2 | 6 | 2 |
| 77 | A1 | 1 | 0 | 9 | 0 | 2 | 6 | 2 |
| 78 | A1 | 1 | 0 | 9 | 7 | 1 | 3 | 2 |
| 79 | A1 | 1 | 0 | 9 | 0 | 1 | 6 | 2 |
| 81 | A1 | 1 | 0 | 4.9 | 0 | 1 | 6 | 2 |
| 85 | A1 | 1 | 0 | 1.3, 5, 7, 9 | 0 | 1 | 6 | 2 |
| . . . | . . . | . . . | . . . | . . . | . . . | . . . | . . . | . . . |
| 145 | B4 | 16 | 1 | 9 | 0 | 2 | 1 | 12 |
| 146 | B4 | 8 | 1 | 9 | 0 | 2 | 1 | 12 |
| 147 | B4 | 4 | 1 | 9 | 2 | 1 | 1 | 12 |
| 148 | B4 | 2 | 1 | 9 | 0 | 1 | 1 | 12 |
| 151 | B4 | 2 | 1 | 4.9 | 2 | 1 | 1 | 12 |
| 152 | B4 | 2 | 1 | 4.9 | 0 | 2 | 1 | 12 |
| 159 | B4 | 1 | 0 | 9 | 0 | 1 | 1 | 12 |
| 160 | B4 | 1 | 0 | 9 | 2 | 1 | 1 | 12 |
| 161 | B4 | 1 | 0 | 9 | 0 | 2 | 1 | 12 |
| 162 | B4 | 1 | 0 | 4.9 | 2 | 1 | 1 | 12 |
| 166 | B4 | 1 | 0 | 1.3, 5, 7, 9 | 2 | 1 | 1 | 12 |

Table 18 shows a portion of an example of TDD configuration in a 3GPP NR system. (D: downlink subframe/symbol, G: guard period/symbol, U: uplink subframe/symbol, and S: special subframe)

TABLE 18

| Frequency range, | DL/UL | Special | Special | Periodi- | Periodi- |
|---|---|---|---|---|---|
| Subcarrier spacing | configuration | subframe 1(S1) | subframe 2(S2) | city 1 | city 2 |
| FR1, 15 k | DDDSU | 10D, 2G, 2U | | 5 | |
| FR1, 30 k | 7DS2U | 6D, 4G, 4U | | 5 | |
| | DDDSU | 10D, 2G, 2U | | 2.5 | |
| | DDDSU DDSUU | 10D, 2G, 2U | | 2.5 | 2.5 |
| | DDDSUU DDDD | 6D, 4G, 4U | | 3 | 2 |
| | DSUU | 12D, 2G | | 7 | |
| | DS1S2U | 10D, 2G, 2U | 12D, 2G, 0U | 1 | 1 |

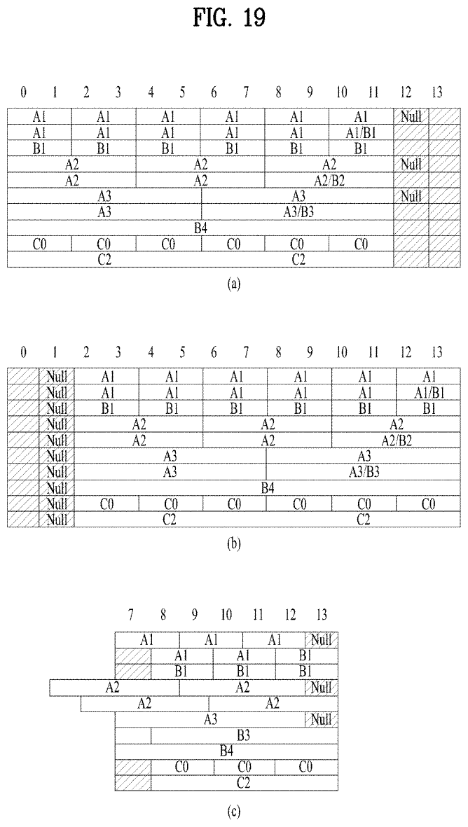

FIG. 19 is a diagram showing an example of a structure of an RACH occasion to which various embodiments of the present disclosure are applicable.

An RACH configuration table defined in a 3GPP NR system may show detailed values of parameters (a Preamble format, Periodicity, SFN offset, an RACH subframe/slot index, a Starting OFDM symbol, a Number of RACH slot, a Number of occasions, OFDM symbols for RACH format, etc.) required for an RACH occasion. When an RACH configuration index is indicated, specific values corresponding to the indicated indexes may be used.

For example, when a starting OFDM symbol parameter is n, one or more RACH occasions from an OFDM symbol having index #n may be configured.

For example, the number of one or more RACH occasions may be indicated by the number of time-domain PRACH occasions within a RACH slot parameter on the time domain.

For example, the RACH slot may include one or more RACH occasions.

For example, the number of RACH slot (in a subframe and/or a slot in a specific SCS) may be indicated by a number of RACH slot parameter.

For example, a system frame number (SFN) including an RACH occasion may be determined based on n_{SFN} mod x=y. mod may refer to the modulo arithmetic or modulo operation and may be an operation for calculating a remainder r obtained by dividing a dividend q by a divisor d (r=q mod (d)).

For example, a subframe/slot (index) in which an RACH occasion is included in a system frame may be indicated by an RACH subframe/slot index parameter.

For example, a preamble format for RACH transmission and reception may be indicated by a preamble format parameter.

Referring to FIG. 19(a), for example, when a starting OFDM symbol is indicated by 0, one or more consecutive RACH occasions from OFDM symbol #0 may be configured. For example, the number of one or more RACH occasions may be dependent upon a value indicated by the number of time-domain PRACH occasions within a RACH slot parameter on the time domain. For example, the preamble format may be indicated by a preamble format parameter. For example, a preamble format A1, A2, A3, B4, C0, or C2 may be indicated. For example, one of the last two OFDM symbols may be used as a protection duration and the other may be used to transmit other UL signals such as a PUCCH or a sounding reference signal (SRS).

Referring to FIG. 19(b), for example, when a starting OFDM symbol is indicated by 2, one or more consecutive RACH occasions (on the time domain) from OFDM symbol #2 may be configured. For example, 12 OFDM symbols may be used for an RACH occasion, and a protection duration may not be configured for the last OFDM symbol. For example, the number of one or more RACH occasions may be dependent upon the number of time-domain PRACH occasions within a RACH slot parameter on the time domain. For example, the preamble format may be indicated by a preamble format parameter. For example, a preamble format A1/B1, B1, A2/B2, A3/B3, B4, C0, or C2 may be indicated.

Referring to FIG. 19(c), for example, when a starting OFDM symbol is indicated by 7, one or more consecutive RACH occasions on the time domain from OFDM symbol #7 may be configured. For example, six OFDM symbols may be used for an RACH occasion and the last OFDM symbol (OFDM symbol #13) may be used to transmit a PUCCH or a sounding reference signal (SRS). For example, the number of one or more RACH occasions may be dependent upon the number of time-domain PRACH occasions within a RACH slot parameter on the time domain. For example, the preamble format may be indicated by a preamble format parameter. For example, a preamble format A1, B1, A2, A3, B3, B4, C0, or C2 may be indicated.

For example, parameters included in the RACH configuration table may satisfy preconfigured correspondence identified/determined by the RACH configuration table and the RACH configuration index. For example, referring to Table 14, RACH configuration index=67 may correspond to RACH format=A1, period (x)=16, SFN offset (y)=1, Subframe index=9, Starting OFDM symbol (index)=0, Number of slots=2, Number of occasions=6, and OFDM symbols for RACH format=2, and this correspondence may be identified by the RACH configuration index and the RACH configuration table.

An RACH slot/subframe index of parameters included in the RACH configuration table may be an index represented based on a specific SCS. For example, the slot/subframe index may be represented based on a SCS of 15 kHz in the case of FR1 and may be represented based on a SCS of 60 kHz in the case of FR2.

When an SCS RACH slot of 30 kHz is used, there may be two SCS RACH slots of 30 kHz that are dependent upon an SCS RACH subframe index of 15 kHz and are represented within a SCS RACH subframe of 15 kHz SCS RACH subframe, and in this regard, all of the two corresponding slots may be used and/or only a second slot of the two corresponding slots may be used, and this value may be indicated according to the RACH configuration table.

However, for example, when all of two RACH slots of 30 kHz are used, overhead may be increased, and thus it may not be possible to reduce the overhead using the current technology. For example, in the case of longer periodicity (e.g., 20, 40, 80, or 160 ms), all of the two RACH slots of 30 kHz are designated to be used, and when only one UL slot of 30 kHz is supported in TDD configuration (e.g., DDDSU), it may not be possible to configure the corresponding RACH configuration.

Various embodiments of the present disclosure may provide a method of overriding, updating, and/or reconfiguring a RACH configuration parameter for configuring an RACH occasion and an apparatus for supporting the method.

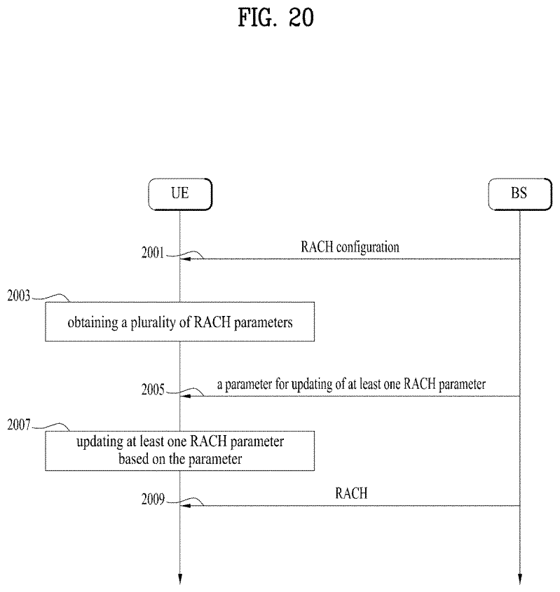

FIG. 20 is a schematic diagram showing an operating method of a UE and a base station (BS) according to various embodiments of the present disclosure.

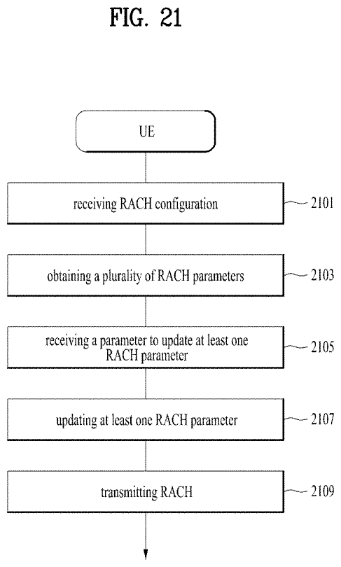

FIG. 21 is a flowchart showing an operating method of a UE according to various embodiments of the present disclosure.

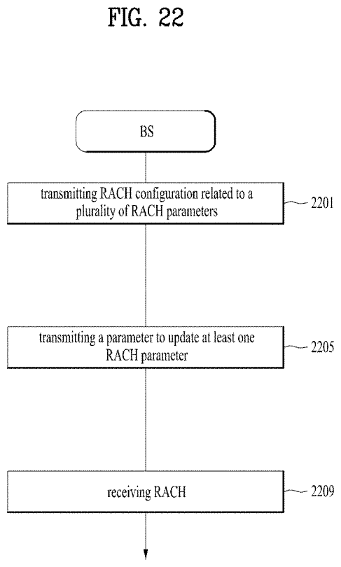

FIG. 22 is a flowchart showing an operating method of a BS according to various embodiments of the present disclosure.

Referring to FIGS. 20 to 22, in operations 2001, 2101, and 2201 according to an exemplary embodiment, the BS may transmit RACH configuration, and the UE may receive the same. For example, the RACH configuration may include an RACH configuration index. For example, a plurality of RACH parameters included in the RACH configuration table may be indicated based on the RACH configuration index.

In operations 2003 and 2103 according to an exemplary embodiment, the UE may acquire a plurality of RACH parameters included in the RACH configuration table based on the RACH configuration index.

In operations 2005, 2105, and 2205 according to an exemplary embodiment, the BS may transmit a parameter for overriding, updating, and/or reconfiguring one or more RACH parameters among the plurality of RACH parameters, and the UE may receive the same.

In operations 2007 and 2107 according to an exemplary embodiment, the UE may override, update, and reconfigure one or more RACH parameters based on the parameter.

In operations 2009, 2109, and 2209 according to an exemplary embodiment, the UE may configure an RACH and may transmit the RACH based on the one more overridden, updated, and/or reconfigured RACH parameters, and the BS may receive the same.

The aforementioned one or more overridden, updated, and/or reconfigured RACH parameters and a detailed method of overriding, updating, and/or reconfiguring one or more RACH parameters may be based on one or more of various embodiments of the present disclosure that will be described below.

More detailed operations, functions, terms, etc. in the operation according to each exemplary embodiment may be performed and described based on various embodiments of the present disclosure to be described later. The operations according to each exemplary embodiment are exemplary, and one or more of the aforementioned operations may be omitted depending on the details of each embodiment.

Hereinafter, various embodiments of the present disclosure will be described in detail. The various embodiments of the present disclosure described below may be combined in whole or in part to constitute other various embodiments of the present disclosure unless mutually exclusive, which will be obvious to those of ordinary skill in the art.

### 3.1. Method#1

For example, when a specific value corresponding to a parameter included in the RACH configuration table is designated according to the RACH configuration index, for a predetermined UE, a RACH occasion may be configured according to a value set by the corresponding RACH configuration index.

And/or, for example, a parameter may be reconfigured according to a value of an additionally indicated parameter for overriding/updating/reconfiguring a value of a related parameter. In this case, for example, for a UE for receiving and applying the parameter, an overridden/updated/reconfigured value may be used to configure an RACH occasion.

For example, the above parameter may be parameters required to configure an RACH occasion and may be one or more parameters among parameters defined in the RACH configuration table.

For example, the above parameter may be one or more of the following parameters. For example, information for overriding/updating/reconfiguring one or more of the following parameters may be transmitted and received, and one or more of the following parameters may be reconfigured according to corresponding information.

RACH configuration index

Periodicity (x)

system frame number (SFN) offset (y) (SFN offset (y))

subframe index

slot index

starting OFDM symbol

number of slot

number of RACH occasion (RO)

Number of time-domain PRACH occasions within a PRACH slot on the time domain

For example, prach-ConfigurationIndex may be a parameter defined in RACH-ConfigGeneric. For example, prach-ConfigurationIndex may be transmitted and received in RACH-ConfigGeneric.

An example of configuration of RACH-ConfigGeneric may refer to Tables 19 to 20 below.

TABLE 19
RACH-ConfigGeneric
The IE RACH-ConfigGeneric is used to specify the random-access parameters both for regular random access
as well as for failure recovery.
RACH-ConfigGeneric Information element

```
-- ASN1START
-- TAG-RACH-CONFIGGENERIC-START
RACH-ConfigGeneric ::=  SEQUENCE {
  prach-ConfigurationIndex  INTEGER (0..255),
  msg1-FDM  ENUMERATED (one, two, four, eight),
  msg1-FrequencyStart  INTEGER (0..maxNrofPhysicalResourceBlocks-1),
  zeroCorrelationZoneConfig  INTEGER (0..15),
  preambleReceivedTargetPower  INTEGER (−202..−60),
  preambleTransMax  ENUMERATED { n3, n4, n5, n6, n7, n8, n10, n20,
n50, n100, n200},
  powerRampingStep  ENUMERATED { dB0, dB2, dB4, dB6},
  re-ResponseWindow  ENUMERATED {sl1, sl2, sl4, sl8, sl10, sl20, sl40,
sl60},
  . . .,
  [[
  ra-ResponseWindow-r16  ENUMERATED {sl1, sl2, sl4, sl8, sl10, sl20, sl40,
sl60, s1l80, sl160} OPTIONAL, -- Need R
  prach-ConfigurationIndex-v16xy  INTEGER  (256..262)
OPTIONAL -- Need R
  ]]
}
-- TAG-RACH-CONFIGGENERIC-STOP
-- ASN1STOP
```

TABLE 20
RACH-ConfigGeneric field descriptions

rnsg1-FDM
The number of PRACH transmission occasions FDMed in one time instance (see TS 38.211 [16]. clause 6.3.3.2).
msg1-FrequencyStart
Offset of lowest PRACH transmission occasion M frequency domain with respective to PRB 0. The value is configured so
that the corresponding RACH resource is entirely within the bandwidth of the UL BWP, (see TS 38.211 [16]. clause 6.3.3.2).
powerRampingStep
Power ramping steps for PRACH (see TS 38.321 [3], 5 1.3).
prach-Configurationlndex
PRACH configuration index. For prach-Configurationindex configured under beamFailureRecovery-Config, the prach-
Configurationindex can only correspond to the short preamble format, (see TS 38.211 [16], clause 6.3.3.2). If the field prach-
Configurationindex-v16xy is present, the UE shall ignore the value provided in prach-ConfigurationIndex (without suffix).
preambleReceivedTargetPower
The target power level at the network receiver side (see TS 38.213 [13], clause 7.4, TS 38.321 [3]. clauses 5.1.2, 5.1.3). Only
multiples of 2 dBm may be chosen (e.g. −202, −200, −198, ...).
preambleTransMax
Max number of RA preamble transmission performed before declaring a failure (see TS 38.321 [3], clauses 5.1.4, 5.1.5).
ra-ResponseWindow
Msg2 (RAR) window length in number of slots. The network configures a value lower than or equal to 10 ms when Msg2 is
transmitted with licensed spectrum channel access and 40 ms when Msg2 is transmitted with shared spectrum channel access
(see TS 38.321 [3], clause 5.1.4). UE ignores the field if included in SCellConfig. If ra-ResponseWindow-r16 is signalled.
UE shall ignore the ra-ResponseWindow (without suffix)
zeroCorrelationZoneConfig
N-CS configuration, see Table 6.3.3.1-5 in TS 38.211 [16].

For example, msgA-PRACH-ConfigurationIndex may be a parameter defined in RACH-ConfigGenericTwoStepRA. For example, msgA-PRACH-ConfigurationIndex may be transmitted and received in RACH-ConfigGenericTwoStepRA.

An example of configuration of RACH-ConfigGenericTwoStepRA may refer to Tables 21 to 23 below.

TABLE 21
RACH-ConfigGenericTwoStepRA
The IE RACH-ConfigGenericTwoStepRA is used to specify the 2-step random access type parameters
RACH-ConfigGenericTwoStepRA information element

```
-- ASN1START
-- TAG-RACH-CONFIGGENERICTWOSTWORA-START
RACH-ConfigGenericTwoStepRA-r16 ::=  SEQUENCE {
  msgA-PRACH-ConfigurationIndex-r16  INTEGER (0..262),
OPTIONAL, -- Cond 2stepOnly
  msgA-RO-FDM-r16  ENUMERATED {one, two, four, eight},
OPTIONAL, -- Cond 2StepOnly
  msgA-PO-FrequencyStart-r16  INTEGER (0..maxNrofPhysicalResourceBlocks-1),
OPTIONAL, -- Cond 2StepOnly
  msgA-zeroCorrelationZoneConfig  INTEGER (0..15),
OPTIONAL, -- Cond 2StepOnly
  msgA-PreamblePowerRampingStep-r16  ENUMERATED { dB0, dB2, dB4, dB6},
OPTIONAL, -- Cond 2StepOnly
  msgA-PreambleReceivedTargetPower-r16  INTEGER  (−202..−60),
OPTIONAL, -- Cond 2StepOnly
  msgB-ResponseWindow-r16  ENUMERATED {sl1, sl2, sl4, sl8, sl10, sl20,
sl40, sl180, sl160, sl320},
  preambleTransMax  ENUMERATED { n3, n4, n5, n6, n7, n8, n10, n20,
n50, n100, n200},
  msgA-TransMax-r16  ENUMERATED {n1, n2, n4, n6, n8, n10, n20, n50,
n100, n200}  OPTIONAL, -- Need R
  . . .
}
-- TAG-RACH-CONFIGGENERICTWOSTEPRA-STOP
-- ASN1STOP
```

TABLE 22
RACH-ConfigGenericTwoStepRA field descriptions

rnsgA-PreamblePowerRampingStep
Power ramping steps for msgA PRACH. if the field is absent, UE shall use the value of powerRampingStep in RACH-
ConfigGeneric in the configured BWP (see TS 38.321 [3]. 5.1.3). This field may only be present if no 4-step type RA is
configured in the BWP or in the case of separate ROs with 4-step type RA.
msgA-PreambleReceivedTargetPower
The target power level at the network receiver side (see TS 38.213 [13], cause 7.1.1 and TS 38.321 [3], clause 5.1.1). Only
multiples of 2 dBm may be chosen (e.g −202, −200, −198, ...). If the field is absent, UE shall use the value of
preambleReceivedTargetPower in RACH-ConfigGeneric in the configured BWP. This field may only be present if no 4-step
type RA is configured in the BWP or in the case of seperate ROs with 4-step type RA.
msgA-PRACH-ConfigurationIndex
Cell-specific PRACH configuration index for 2-step RA type. If the field is absent the UE shall use the value of corresponding
4-step random access parameter in the configured BWP. if the value is in the range of 256 to 262, the field prach-
ConfigurationIndex-v16xy should be considered configured (see TS 38.211 [16], clause 6.3 3.2). This field may only be
present if no 4-step type RA is configured in the BWP or in the case of separate ROs with 4-step type RA.
rnsgA-RO-FDM
The number of msgA PRACH transmission occasions Frequency-Division Multiplexed in one time instance. If the fieid is absent,
UE shall use value of msg1-FDM, in RACH-ConfigGeneric in the configured BWP (see TS 38.211 [16], clause 6.3.3.2).
This field may only be present if no 4-step type RA the configured in the BWP or in the case of separate ROs with
4-step type RA. rnsgA-RO-FrequencyStart
Offset of lowest PRACH transmissions occasion in frequency domain with respect to PRB 0. If the field is absent, UE shall use
value of msg1-FrequencyStart in RACH-ConfigGeneric in the configured BWP (see TS 38.211 [16]], clauses 5.3.2 and 6.3.3.2).
This field may only be present if no 4-step type RA is configured in the BWP or in the case of separate ROs with 4.step type RA
is msgA-Tran.sMax
Max number of MsgA preamble transmissions performed before switching to 4-step random access (see TS 38.321 [3], clauses
5.1.1). This field may only be applicable in case of 2-step and 4-step RA type are configured or switching to 4-step type RA is
not supported.
msgA-ZeroCorrelationZoneConfig
N-CS configuration for msgA preamble, see Table 6.3.3.1-5 in TS 38.211 [16]. If the field is absent, UE shall use value
zeroCorrelationZoneConfig in RACH-ConfigGeneric in the configured BWP This field may only be present if no 4-step type
RA is configured in the BWP or in the case of separate ROs with 4-step type RA.
msgB-ResponseWindow
MsgB monitoring window length in number of slots. The network configures a value lower than or equal to 40 ms
(see TS 38.321 [3], clause 5.1.1).
preambleTransWax
Max number of RA preamble transmission performed before declaring a failure (see TS 38.321 [3], clauses 5.1.4, 5.1.5).

TABLE 23

| Conditional | |
|---|---|
| Presence | Explanation |
| 2StepOnly | The field is mandatory present if there are |
| | no 4-step random access configurations |
| | configured in the BWP, i.e only 2-step |
| | random access type configured in the |
| | BWP, otherwise the field is Need S |

In the description of the present section and various embodiments of the present disclosure, prach-ConfigurationIndex may be changed to msgA-PRACH-ConfigurationIndex, and in this case, various embodiments of the present disclosure may also be applied.

For example, RACH-ConfigGeneric may be a parameter defined in ServingCellConfigCommon or ServingCellConfigCommonSIB. For example, RACH-ConfigGeneric may be transmitted and received in ServingCellConfigCommon or ServingCellConfigCommonSIB.

An example of configuration of ServingCellConfigCommon may refer to Table 24 below.

TABLE 24
ServingCellConfigCommon

```
physCellId  PhysCellId
uplinkConfigCommon  UplinkConfigCommon
  initialUplinkBWP  BWP-UplinkCommon
    rach-ConfigCommonSetupRelease { RACH-ConfigCommon }
                          rach-ConfigGeneric RACH-ConfigGeneric
```

Information element (IE) ServingCellConfigCommon may be used to configure a cell-specific parameter of a serving cell of a UE. ServingCellConfigCommon may generally include a parameter acquired from an SSB, an MIB, or an SIB when the UE accesses a cell from an idle state. Through ServingCellConfigCommon, a network may provide this information via dedicated signaling when a secondary cell (SCell) or a secondary cell group (SCG) is configured. ServingCellConfigCommon may provide this information for a special cell (SpCelll) (master cell group (MCG) and SCG) when synchronization is configured.

An example of configuration of ServingCellConfigCommonSIB may refer to Table 25 below.

TABLE 25
ServingCellConfigCommonSIB

```
UplinkConfigeCommonSIB
  initialUplinkBWP  BWP-UplinkCommon
    rach-ConfigCommonSetupRelease { RACH-ConfigComman }
      rach-ConfigGeneric RACH-ConfigGeneric
```

IE ServingCellConfigCommonSIB may be used to configure a cell-specific parameter of a serving cell of a UE in SIB1.

In another example, RACH-ConfigGeneric may be a parameter defined in RACH-ConfigCommon or the like. For example, RACH-ConfigGeneric may be transmitted and received in RACH-ConfigCommon or the like. For example, IE RACH-ConfigCommon may be used to specify a cell-specific random-access parameter.

For example, RACH-ConfigGenericTwoStepRA may be a parameter defined in RACH-ConfigCommonTwoStepRA or the like. For example, RACH-ConfigGenericTwoStepRA may be transmitted and received in RACH-ConfigCommonTwoStepRA or the like. For example, IE RACH-ConfigCommonTwoStepRA may be used to specify a cell-step 2-step random-access type parameter.

### 3.1.0. Embodiment 0

In the following description of various embodiments of the present disclosure, a value may be the above parameter. For example, the value may be parameters required to configure an RACH occasion and may be one or more of two parameters defined in the RACH configuration table.

1) For example, when prach-ConfigurationIndex is indicated, if a parameter for changing the value is additionally indicated:

Rel-15 UE (Legacy UE) may operate according to prach-ConfigurationIndex.

From Rel-16 UE (UE having a new function), a UE may operate according to a value changed by a parameter of (UE for supporting REL-16 and/subsequent technology).

2) For example, when prach-ConfigurationIndex is indicated, if a parameter for changing prach-ConfigurationIndex-r16 as a new index and the value is indicated:

Rel-15 UE may operate according to prach-ConfigurationIndex.

From Rel-16 UE, a UE may operate according to a new index and a value changed by the parameter.

3) For example, when prach-ConfigurationIndex-r16 as a new index and a parameter for changing the value are indicated:

From Rel-16 UE, a UE may operate according to the new index and a value changed by the parameter.

4) For example, prach-ConfigurationIndex may be indicated, and based on this index, a parameter indicating a new index may be indicated:

4-1) For example, a parameter may indicate an index offset value. For example, RACH may be performed according to a value indicated by an index that is separated by an offset indicated by a parameter based on the prach-ConfigurationIndex.

4-2) For example, there may be an RACH preamble format determined according to prach-ConfigurationIndex, and in this regard, other indexes corresponding to the format may be configured as candidate indexes, and a specific index may be indicated among the candidate indexes.

### 3.1.1. Embodiment 1

For example, a value of the number of PRACH slots within a subframe/slot may be overridden/updated/reconfigured according to a parameter indicating the number of RACH slots.

For example, there may be a parameter such as prach-NumSlot-r16. For example, a value set by the parameter may be assumed to be {1^{st} slot, 2^{nd} slot, both slots}. For example, when the value indicates a 1^{st} slot, an RACH occasion may be configured in a first RACH slot among various RACH slots (two slots in the case of 30 kHz) of a short duration included in an RACH subframe (or a slot of 60 kHz). For example, when the value indicates a 2^{nd} slot, an RACH occasion may be configured in a second RACH slot among various RACH slots (two slots in the case of 30 kHz) of a short duration included in an RACH subframe (or a slot of 60 kHz). For example, when the value indicates both slots, an RACH occasion may be configured in all of various RACH slots (two slots in the case of 30 kHz) of a short duration included in an RACH subframe (or a slot of 60 kHz).

For example, a value set by a parameter may also be represented by {one slot, two slots}. For example, when the value indicates one slot, a 2^{nd} slot may be interpreted as being used. For example, when the value indicates one slot, an RACH occasion may be configured in a 2^{nd} slot. For example, when the value indicates two slots, all of the 1^{st} slot and the 2^{nd} slot may be used. For example, when the value indicates two slots, an RACH occasion may be configured in the 1^{st} slot and the 2^{nd} slot.

### 3.1.2. Embodiment 2

For example, a value of the number of time-domain PRACH occasions within a PRACH slot on the time domain may be overridden/updated/reconfigured according to a parameter indicating the value.

For example, there may be a parameter such as prach-NumTDRO-r16. For example, a value set by the parameter may be assumed to be {1,2, . . . , N}. For example, an RO may be used according to a value indicated by the parameter among candidate ROs determined according to a starting OFDM symbol and an RACH format in a RACH slot.

For example, when {1} is designated, one RO having a low(est) index may be used among ROs. For example, when {N} is designated, all of the candidate ROs may be used. For example, N may be a natural number.

### 3.1.3. Embodiment 3

For example, a value of the Periodicity (x) may be overridden/updated/reconfigured according to a parameter indicating the value.

For example, there may be a parameter such as Periodicity-r16. For example, a value set by the parameter may be assumed to be {1, 2, 4, 8, 16}. For example, when the value indicates 2, the parameter may be newly configured to have periodicity of 20 ms. For example, 1, 2, 4, 8, and 16 may correspond to 10 ms, 20 ms, 40 ms, 80 ms, and 160 ms, respectively.

### 3.1.4. Embodiment 4

For example, a value of the SFN offset (y) may be overridden/updated/reconfigured according to a parameter indicating the value.

For example, there may be a parameter such as SFNoffset-r16. For example a value set by the parameter may be assumed to be {0,1}. For example, when the value indicates 0, an RACH may be configured in 0 offset of SFN in a unit of 10 ms within periodicity, that is, in a first frame. For example, when value indicates 1, the RACH may be configured in 1 offset of SFN in a unit of 10 ms within periodicity, that is, in a second frame.

### 3.1.5. Embodiment 5

For example, a value of the subframe index/slot index may be overridden/updated/reconfigured according to a parameter indicating the value.

### 3.1.6. Embodiment 6

For example, a value of the starting OFDM symbol (index) may be overridden/updated/reconfigured according to a parameter indicating the value. For example, when the value is overridden/updated/reconfigured, the number of ROs to be used in an RACH slot may be changed.

### 3.1.7. Embodiment 7

For example, when an NR-U fails in a Channel access procedure (CAP) for a message A PUSCH in a 2-Step RACH procedure, an operation for reducing a CAP for a message A PRACH and PUSCH for reducing potential latency may be required.

For example, in order to reduce the CAP for the message A PRACH and PUSCH, a message A needs to be configured based on a principle of configuring a timing gap between a message A preamble and a message A PUSCH to be shorter than 16 us.

For example, according to the aforementioned principle, a preamble format (e.g., a preamble format A1, A2, or A3) that does not include a guard time needs to be configured. For example, according to the guard time of the preamble format, another preamble format (e.g., a preamble format A1/B1, A2/B2, or A3/B3) having a guard time may also be configured.

For example, in the NR-U, one value (e.g., 15k Hz or 30 kHz) of two SCSs may be configured for a PRACH preamble.

Table 26 shows an example of a guard time (unit of us) of a PRACH preamble format.

TABLE 26

| Preamble format | B1 | B2 | B3 | B4 |
|---|---|---|---|---|
| For 15 kHz SCS | 9.375 | 18.75 | 23.125 | 56.25 |
| For 30 kHz SCS | 4.6875 | 9.375 | 14.0625 | 28.125 |

Referring to Table 26, for example, in the case of a SCS of 15 kHz, a guard time of a preamble format B1 may satisfy time gap requirements (e.g., less than 16 us).

For example, in the case of a SCS of 30 kHz, a guard time of a preamble format B1, B2, or B3 may be less than 16 us. Thus, in the case of a SCS of 30 kHz, for example, an OFDM symbol after a preamble format B1, B2, or B3 may be allocated to a message A PUSCH.

In another example, an SCS may be considered. For example, when different SCSs are configured between the message A preamble and the message A PUSCH, a switching time may be required. Thus, for example, the same SCS may be configured between the message A preamble and the message A PUSCH.

In short, for example, for the NR-U, the timing gap between the message A preamble and the message A PUSCH may be shorter than 16 us.

For example, a preamble format (e.g., a preamble format A1, A2, or A3) that does not include a guard time may be configured and/or a preamble format (e.g., a preamble format A1/B1, A2/B2, or A3/B3) that includes a short guard time may be configured according to a SCS.

For example, the same SCS may be configured between the message A preamble and the message A PUSCH.

For example, in order to allow a shorter timing gap between the message A preamble and the message A PUSCH, two approaches for allocating consecutive OFDM symbols for the message A preamble and the message A PUSCH may be considered as follows:

Consecutive OFDM symbols in a slot

Consecutive OFDM symbols in consecutive two slots

However, when the current RACH configuration is used, it may not be easy to allocate consecutive OFDM symbol for the message A preamble and the message A PUSCH.

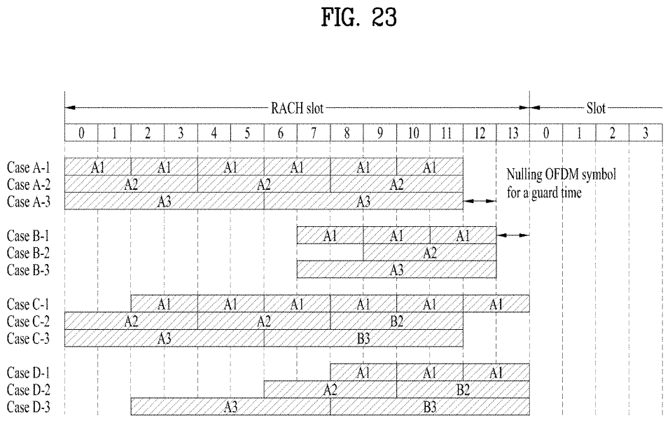

FIG. 23 is a diagram showing an example of a configuration of an RACH occasion to which various embodiments of the present disclosure are applicable. FIG. 23 is a diagram showing an RACH occasion according to the current RACH configuration.

Referring to FIG. 23, for example, 12 OFDM symbols may be used for an RO, and ROs may be consecutively allocated within an RACH slot. Thus, it may be difficult to configure a RACH preamble and a PUSCH within a slot.

In the current RACH configuration, for example, there may be no case in which one RACH occasion using a preamble format A1, A2, or A3 to an end of slot. Thus, for example, it may be difficult to allocate a PUSCH resource to an OFDM symbol of a next slot.

For example, referring to CaseA-1/A-2/A-3/B-1/B-2/B-3, etc., one or more RACH occasions for each preamble format may be configured within an RACH slot, and OFDM symbol #12 and/or OFDM symbol #13 may be a null (nulling) OFDM symbol for a guard time. In this case, for example, even if a PUSCH from OFDM symbol #0 of a next slot is mapped, a guard time including OFDM symbol #12 and/or OFDM symbol #13 may be a rather long time (e.g., greater than 16 us) to transmit (a message A including) a PRACH preamble and a PUSCH through one time CAP. In this case, for example, a CAP for PUSCH transmission needs to be separately performed, thereby increasing latency in an RACH procedure.

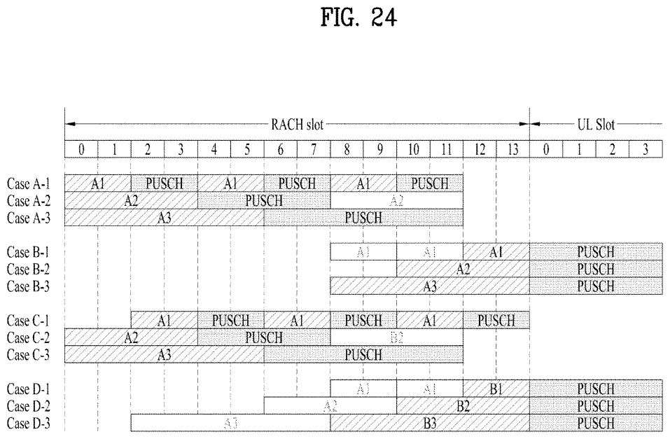

FIG. 24 is a diagram showing an example of an RACH occasion configuration modification according to various embodiments of the present disclosure. FIG. 24 illustrates an RACH occasion within an RACH slot. FIG. 24 illustrates an example of configuration of a message A based on modified RACH configuration obtained by modifying the RACH configuration of FIG. 23 to allow the aforementioned configuration of the message A (e.g., configuration for allowing a shorter timing gap between the message A preamble and the message A PUSCH).

Referring to FIG. 24, for example, when the following two modification cases are allowed, a network may configure a message A with no or less timing gap between the preamble and the PUSCH:

A subset of an RO in a slot is used (e.g., CaseA-1/2/3, Case B-1, Case C-1/2/3, or Case D-1/2/3): For example, only some of ROs in the slot may be used for a PRACH preamble, and at least some of the other ROs may be used for a PUSCH. For example, referring to CaseA-1, three ROs (RO including each of 0/1, 4/5, and 8/9 OFDM symbols) of the six ROs (refer to FIG. 23) for PRACH preamble Al may be used for the PRACH preamble A1, and the other three ROs (RO including each 2/3, 6/7, and 10/11 OFDM symbols) may be used for a PUSCH.

Change in starting OFDM symbol (e.g., Case B-1/2/3): For example, a starting OFDM symbol for an RO may be changed/shifted. For example, referring to Case B-1, a starting OFDM symbol for three ROs (refer to FIG. 23) for the PRACH preamble A1 may be changed to #8 (or #12) from #7. For example, according to the change, OFDM symbol #13 may not be a null OFDM symbol (refer to FIG. 23), and the RACH preamble A1 may not include a guard time, and thus the PRACH preamble A1 may be continuous with a PUSCH allocated from OFDM symbol #0 in a next slot.

For example, for RACH configuration modification, the following alternative approaches may be considered:

Alt.1: Introduction of new RACH configuration entity above current RACH table

Alt.2: Application of parameter (e.g., msgA-ssb-sharedROmaskindex) for using subset of RO in slot

Alt.3: Introduction of parameter for overriding/updating/reconfiguring parameters configured as RACH configuration (e.g., the number of occasion or starting OFDM symbols)

For example, an RACH configuration table in a 4-Step RACH procedure may also be used in a 2-Step RACH procedure. For example, the aforementioned Alt.1 is equivalent to introduction of a new table of a size of N bits (N being a natural number, e.g., a size of 9 bits) for configuration, and thus it may be difficult to accept Alt. 1.

For example, in the case of a shared RO (e.g., an RO is shared between a 2-Step RACH procedure and a 4-Step RACH procedure), a subset of an RO related to the same SS/PBCH index may be shared. For example, one RRC parameter (e.g., msgA-ssb-sharedROmaskindex) may be introduced. For example, in consideration of the case in which this subset restriction is applied to a special case (e.g., when one SSB is mapped to a plurality of ROs), it may be difficult to satisfy a condition (e.g., one RO is allocated to an end of slot) requested by the NR-U.

Thus, for example, for more flexible allocation of a PRACH occasion, it may be appropriate to introduce a parameter for overriding/updating/reconfiguring of a value of a parameter configured by PRACH configuration. In addition, this method may also be applied to a general 2-Step RACH procedure as well as the NR-U.

In short, for example, a parameter for overriding/updating/reconfiguring of a value of the parameter configured by the PRACH configuration may be introduced. For example, a parameter for changing the number of occasions, starting OFDM symbols, and so on may be introduced.

For example, one or more of the following methods may be considered as a method of designating a subset of temporally continuous ROs:

1) Designating/indicating method using bitmap

2) Method of designating/indicating only some ROs (like an interlaced structure)

3) Method in which ROs that exist temporally sequentially in the front (or rear) are used when the number of ROs is designated/indicated (e.g., a designated number of ROs from the first RO of an entire temporally continuous RO set may be a subset)

4) Method in which ROs that exist temporally sequentially in the front (or rear) are not used and the remaining ROs are used when the number of ROs is designated/indicated (e.g., a designated number of ROs from the first RO of an entire temporally continuous RO set may be a subset of the remaining ROs)

For example, when an RO is designated, the designated RO may be considered to be valid, and a non-designated RO may be considered to be invalid. In contrast, for example, when an RO is designated, the designated RO may be considered to be valid, and a non-designated RO may be considered to be valid. For example, SSB-to-RO mapping may be performed on valid ROs.

For example, when temporally continuous ROs are designated, all ROs of a frequency included in a time when the RO is present may also be valid or invalid. For example, when temporally continuous designated ROs are valid, all ROs of a frequency included in a time when the designated RO is present may be valid or invalid. For example, when temporally continuous designated ROs are invalid, all ROs of a frequency included in a time when the designated RO is present may be valid or invalid.

### 3.2. Method #2

An example of configuration of LTE TDD UL-DL may refer to Table 27 below. (D: downlink subframe, S: special subframe, and U: uplink subframe)

TABLE 27

| Uplink- | Downlink-to- | | | | | | | | | | |
|---|---|---|---|---|---|---|---|---|---|---|---|
| downlink | Uplink | | | | | | | | | | |
| con- | Switch-point | Subframe number | | | | | | | | | |
| figuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

For example, LTE-NR coexistence may be defined. For example, all of a time-frequency resource for LTE and a time-frequency resource for NR may be included in a predetermined resource region configured with a time-frequency resource. For example, an LTE DL/UL time resource and an NR DL/UL time resource may be aligned.

For example, in addition to RACH configuration corresponding to prach-ConfigurationIndex or the like, coexistence of LTE TDD UL-DL configuration x (x=0, 1, 2) may be indicated via signaling.

For example, when signaling of LTE TDD UL-DL configuration x (x=0, 1, 2) and coexistence is transmitted and received, it may be interpreted that an RACH resource of an NR subframe index−x instead of an RACH resource of an NR subframe index (e.g., 4 or 9) included in the RACH configuration table needs to be used.

For example:

NR subframe 4, 9 is aligned with LTE TDD UL-DL configuration 0;

NR subframe 3, 8 is aligned with LTE TDD configuration 1;

NR subframe 2, 7 is aligned with LTE TDD configuration 2;

Accordingly, for example:

When signaling of −x=0 and coexistence is transmitted and received (when signaling of x=0 and coexistence is indicated), an RACH resource of {4, 9} of a subframe may be used. For example, an RACH may be transmitted in an RACH resource of {4, 9} of a subframe may be transmitted and received.

When signaling of −x=1 and coexistence is transmitted and received (when signaling of x=1 and coexistence is indicated), an RACH resource of {3, 8} of a subframe may be used. For example, an RACH may be transmitted in an RACH resource of {3, 8} of a subframe may be transmitted and received. ({4−1=3, 9−1=8}={3, 8})

When signaling of −x=2 and coexistence is transmitted and received (when signaling of x=2 and coexistence is indicated), an RACH resource of {2, 7} of a subframe may be used. For example, an RACH may be transmitted in an RACH resource of {2, 7} of a subframe may be transmitted and received. ({4−2=2, 9−2=7}={2, 7})

The aforementioned various embodiments of the present disclosure may also be applied to the LTE TDD configurations 3, 4, 5, 6, etc. When various embodiments of the present disclosure including the LTE TDD configurations 3, 4, 5, 6, etc. are applied, −min {x, 2} (x=0, 1, 2, 3, 4, 5, 6) instead of −x may be defined while a range that satisfies a condition is used.

For example, when signaling of LTE TDD UL-DL configuration x (x=0, 1, 2, 3, 4, 5, 6) and coexistence is transmitted and received, it may be interpreted that an RACH resource of NR subframe index−min {x, 2} instead of an RACH resource of an NR subframe index included in an RACH configuration table needs to be used.

### 3.3. Method #3

In the present section, a first UE may be, for example, a UE for supporting release prior to Rel-16 (e.g., Rel-15).

In the present section, a second UE may be, for example, a UE for supporting Rel-16 and release thereafter.

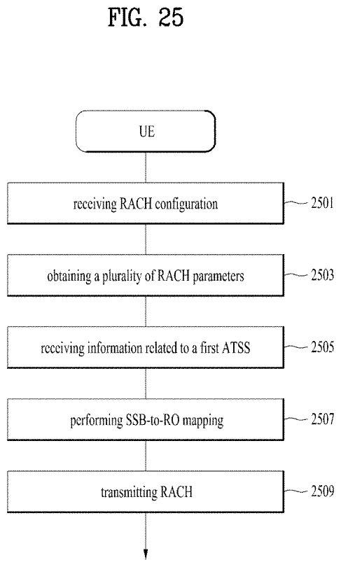

FIG. 25 is a flowchart showing an operating method of a first UE according to various embodiments of the present disclosure.

Referring to FIG. 25, in operation 2501 according to an exemplary embodiment, the first UE may receive RACH configuration. For example, the RACH configuration may include an RACH configuration index.

In operation 2503 according to an exemplary embodiment, the first UE may acquire a plurality of RACH parameters included in an RACH configuration table based on the RACH configuration index.

In operation 2505 according to an exemplary embodiment, the first UE may receive information related to a first actually transmitted synchronization signal block (ATSS). For example, the information of the first ATSS may be received through ServingCellConfigCommonSIB (and/or ServingCellConfigCommonSIB1) and/or ServingCellConfigCommon. For example, the information related to the first ATSS may have the same value as information related to the second ATSS for the second UE or may have a different value therefrom.

In operation 2507 according to an exemplary embodiment, the first UE may perform SSB-to-RO mapping based on information related to RACH configuration and the first ATSS.

In operation 2509 according to an exemplary embodiment, the first UE may transmit an RACH.

More detailed operations, functions, terms, etc. in the operation according to each exemplary embodiment may be performed and described based on various embodiments of the present disclosure to be described below in the present section. The operations according to each exemplary embodiment are exemplary, and one or more of the aforementioned operations may be omitted depending on the details of each embodiment.

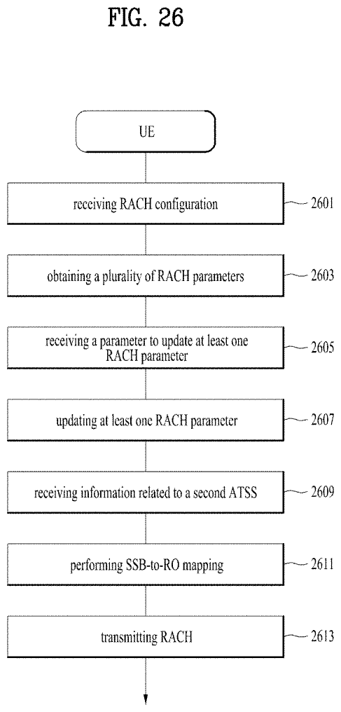

FIG. 26 is a flowchart showing an operating method of a second UE according to various embodiments of the present disclosure.

Referring to FIG. 26, in operation 2601 according to an exemplary embodiment, the second UE may receive RACH configuration. For example, the RACH configuration may include an RACH configuration index.

In operation 2603 according to an exemplary embodiment, the second UE may acquire a plurality of RACH parameters included in an RACH configuration table based on an RACH configuration index.

In operation 2605 according to an exemplary embodiment, the second UE may receive a parameter for overriding, updating, and/or reconfiguring one or more RACH parameters of a plurality of RACH parameters.

In operation 2607 according to an exemplary embodiment, the second UE may override, update, and/or reconfigure one or more RACH parameters based on the parameter.

In operation 2609 according to an exemplary embodiment, the second UE may receive information related to the second ATSS. For example, the information related to the second ATSS may be received through ServingCellConfigCommonSIB (and/or ServingCellConfigCommonSIB1) and/or ServingCellConfigCommon. For example, the information related to the second ATSS may have the same value as the information related to the first ATSS for the first UE or may have a different value therefrom.

In operation 2611 according to an exemplary embodiment, the second UE may perform RACH configuration and may perform SSB-to-RO mapping based on one or more overridden, updated, and/or reconfigured RACH parameters and the information related to the second ATSS.

In operation 2613 according to an exemplary embodiment, the second UE may be transmitted the RACH.

More detailed operations, functions, terms, etc. in the operation according to each exemplary embodiment may be performed and described based on various embodiments of the present disclosure to be described below in the present section. The operations according to each exemplary embodiment are exemplary, and one or more of the aforementioned operations may be omitted depending on the details of each embodiment.

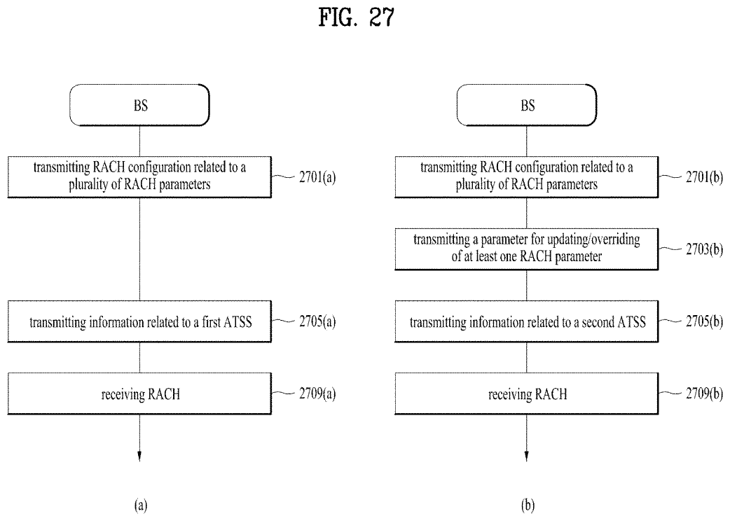

FIG. 27 is a flowchart showing an operating method of a BS according to various embodiments of the present disclosure.

For example, FIG. 27(a) illustrates an operation of a BS corresponding to an operation of the first UE, and FIG. 27(b) illustrates an operation of a BS corresponding to an operation of the second UE.

Referring to FIG. 27(a), in operation 2701(a) according to an exemplary embodiment, the BS may transmit RACH configuration. For example, the RACH configuration may include an RACH configuration index.

In operation 2705(a) according to an exemplary embodiment, the BS may transmit information related to the first ATSS. For example, the information related to the first ATSS may be for the first UE. For example, the information related to the first ATSS may be transmitted through ServingCellConfigCommonSIB (and/or ServingCellConfigCommonSIB1) and/or ServingCellConfigCommon. For example, the information related to the first ATSS may have the same value as the information related to the second ATSS for the second UE or may have a different value therefrom.

In operation 2707(a) according to an exemplary embodiment, the BS may receive the RACH. For example, the RACH may be related to one or more of the RACH configuration and/or the information related to the first ATSS.

Referring to FIG. 27(b), in operation 2701(b) according to an exemplary embodiment, the BS may transmit the RACH configuration. For example, the RACH configuration may include an RACH configuration index.

In operation 2703(b) according to an exemplary embodiment, the BS may transmit a parameter for overriding, updating, and/or reconfiguring one or more RACH parameters among a plurality of RACH parameters.

In operation 2705(b) according to an exemplary embodiment, the BS may transmit information related to a second ATSS. For example, the information related to the second ATSS may be for the second UE. For example, the information related to the second ATSS may be transmitted through ServingCellConfigCommonSIB (and/or ServingCellConfigCommonSIB1) and/or ServingCellConfigCommon. For example, the information related to the second ATSS may have the same value as the information of the first ATSS for the first UE or may have a different value therefrom.

In operation 2707(b) according to an exemplary embodiment, the BS may receive an RACH. For example, the RACH may be related to one or more of the RACH configuration, the parameter, and/or the information related to the second ATSS.

Transmission and reception in an operation according to each embodiment may include unicast/broadcast/multicast transmission and reception, etc.

For example, the first UE and the second UE may coexist and/or only the second UE may be present without the first UE.

For example, when the first UE and the second UE coexist, the information related to the first ATSS may be transmitted and received through ServingCellConfigCommon, and/or the information related to the second ATSS may be transmitted and received through ServingCellConfigCommonSIB (and/or ServingCellConfigCommonSIB1).

For example, when both of the first and second UEs are standalone (SA), both of the information related to the first ATSS and the information related to the second ATSS may be transmitted and received through ServingCellConfigCommonSIB (and/or ServingCellConfigCommonSIB1).

For example, when only the second UE is present, the information related to the second ATSS may be transmitted and received through ServingCellConfigCommonSIB (and/or ServingCellConfigCommonSIB1) and/or ServingCellConfigCommon.

More detailed operations, functions, terms, etc. in the operation according to each exemplary embodiment may be performed and described based on various embodiments of the present disclosure to be described below in the present section. The operations according to each exemplary embodiment are exemplary, and one or more of the aforementioned operations may be omitted depending on the details of each embodiment.

Hereinafter, various embodiments of the present disclosure will be described in detail. The various embodiments of the present disclosure described below may be combined in whole or in part to constitute other various embodiments of the present disclosure unless mutually exclusive, which will be obvious to those of ordinary skill in the art.

For example, the maximum of 4/8/64 SSBs may be transmitted and received according to an SCS, but in an actual wireless communication system, the maximum of SSBs or less (i.e., 4 or less/8 or less/64 or less in each SCS) may be transmitted and received. Thus, for example, the UE needs to know the number of SSBs that are actually transmitted and received to and from the BS, and the BS may notify the UE of information on the actually transmitted SSB. For example, this information may be defined as actually transmitted synchronization signal block (ATSS) information.

For example, when rate matching and/or SSB-to-RO mapping are performed, ATSS information for the first UE may be used. And/or for example, there may be ATSS information that is additionally indicated for the second UE, and when this information is indicated, the second UE may perform SSB-to-RO mapping using the additionally indicated information.

For example, the number of actually transmitted SSBs may be determined by ssb-PositionsInBurst in SIB1.

For example, ssb-PositionsInBurst may be a parameter included in ServingCellConfigCommonSIB. An example of configuration of ServingCellConfigCommonSIB may refer to Tables 28 to 30 below.

TABLE 28
ServingCellConfigCommonSib
The IE ServingCellConfigCommonSIB is used to configure cell specific parameters of a UE's serving cell in SIB1.
ServingCellConfigCommonSIB information element

```
--ASN1START
--TAG--SERVINGCellCONFIGCOMMONSIB-START
ServingCellConfigCommonSIB ::= SEQUENCE {
  downlinkConfigCommon  DownlinkConfigCommonSIB,
  uplinkConfigCommon  UplinkConfigCommonSIB
OPTIONAL, --Need R
  supplementary UplinkConfigCommonSIB
OPTIONAL, -- Need R
  n-TimingAdvanceOffset  ENUMERATED { n0, n25600, n39936 }
OPTIONAL, -- Need S
  ssb-PositionsInBurst  SEQUENCE }
    inOneGroup  BIT STRING (SIZE (8)),
    groupPresence   BIT STRING (SIZE (8))
OPTIONAL -- Cond FR2-Only
  },
  ssb-PeriodicityServingCell  ENUMERATED {ms5, ms10, ms20, ms40, ms80, ms160},
  tdd-UL-DL-ConfigurationCommon  TDD-UL-DL-ConfigCommon
OPTIONAL, -- Cond TDD
  ss-PBCH-BlockPower  INTEGER (−60..50),
  ...,
  [[
  channelAccessMode-r16  CHOICE {
    dynamic  NULL,
    semistatic  SemiStaticChannelAccessConfig
}
OPTIONAL, -- Need M
  discoveryBurstWindowLength-r16  ENUMERATED [s0dot5, s1, s2, s3, s4, s5}
OPTIONAL -- Need M
  ]]
}
-- TAG-SERVINGCELLCONFIGCOMMONSIB-STOP
-- ASNISTOP
```

TABLE 29
ServingCellConfigCommonSIB field descriptions

channelAccessMode
If the field is configured as “semistatic”, the channel access procedures for semi-static channel occupancy as described in
subclause 4.3 in TS 37.213 are applied. Otherwise, if the field is configured as “dynamic” or it the field is absent, the channel
access procedures in TS 37.213, with exception of subclause 4.3 of TS 37.213, are applied.
discoveryBurstWindowLength
Indicates the window length of the discocery burst in ms (see TS 37.213 [48]).
groupPresence
This field is present when maximum number of SS/PBCH blocks per half frame equals to 64 as defined in TS 38.213 [13], clause
4.1. The first/leftmost bit corresponds to the SS/PBCH index 0-7, the second bit corresponds to SS/PBCH block 8-15, and so on.
Value 0 in the bitmap indicates that the SSBs according to inOneGroup are absent. Value 1 indicates that the SS/PBCH blocks
are transmitted in accordance with inOneGroup.
inOneGroup
When maximum number of SS/PBCH blocks per half frame equals to 4 as defined in TS 38.213 [13], clause 4.1, only the 4
leftmost bits are valid; the UE ignores the 4 rightmost bits. When maximum number of SS/PBCH blocks per half frame equals to
8 as defined in TS 38.213 [13]. clause 4.1, all 8 bits are valid. The first/leftmost bit corresponds to SS/PBCH block index 0, the
second bit corresponds to SS/PBCH block index 1, and so on. When maximum number of SS/PBCH blocks per half frame
equals to 64 as defined in TS 38.213 [13], clause 4.1, all 8 bit are valid; The first/leftmost bit corresponds to the first SS/PBCH
block index in the group (i.e., to SSB index 0, 8, and so on); the second it corresponds to the second SS/PBCH block index in
the group (i.e., to SSB index 1, 9, and so on), and so on. Value 0 in the bitmap indicates that the corresponding SS/PBCH block
is not transmitted while value 1 indicates that the corresponding SS/PBCH block is transmitted.
n-TimingAdvanceOffset
The N_TA-Offset to be applied to random access on this serving cell. If the field is absent, the UE applies the value defined for
the duplex mode and frequency range of this serving cell. See TS 38.133 [14], table 7.1.2-2.
semiStaticChannelAccessConfig
The parameters for semi-static channel access. The network configures this only when channelAccessMode is set to semistatic.
ssb-PositionSinBurst
Time domain positions of the transmitted SS-blocks in an SS-burst as defined in TS 38.213 [13], clause 4.1. For operation with
shared spectrum channel access, only mediumBitmap is used. The UE assumes that a bit at position k > ssb-PositionQCL is 0.
ss-PBCH-BlockPower
Average EPRE of the resources elements that carry secondary synchronization signals in dBm that the NW used for SSB
transmission, see TS 38.213 [13], clause 7.

TABLE 30

| Conditional | |
|---|---|
| Presence | Explanation |
| FR2-Only | This field is mandatory present for an FR2 carrier |
| | frequency. It is absent otherwise and DE releases |
| | any configured value. |
| TDD | The field is optionally present. Need R, for TDD |
| | cells; otherwise it is absent. |

For example, during an operation in standalone (SA), rate matching and/or SSB-to-RO mapping may be performed ssb-PositionsInBurst indicated by the SIB1.

For example, new ssb-PositionsInBurst (e.g., ssb-PositionsInBurst-16r/ssb-PositionsInBurst-r16) for the second UE may be indicated. For example, ssb-PositionsInBurst-16r/ssb-PositionsInBurst-r16 may be included in ServingCellConfigCommonSIB.

For example, when parameter ssb-PositionsInBurst and additional parameter ssb-PositionsInBurst-r16 are indicated, the first UE may be based on parameter ssb-PositionsInBurst and the second UE may be based on additional parameter ssb-PositionsInBurst-16r/ssb-PositionsInBurst-r16. For example, the first UE may perform rate matching and/or SSB-to-RO mapping according to parameter ssb-PositionsInBurst. For example, the second UE may perform rate matching and/or SSB-to-RO mapping according to an additional parameter (ssb-PositionsInBurst-16r/ssb-PositionsInBurst-r16).

For example, ssb-PositionsInBurst may be a parameter included in ServingCellConfigCommon. An example of configuration of ServingCellConfigCommon may refer to Tables 31 to 34 below.

TABLE 31
ServingCellConfigCommon
The IE ServingCellConfigCommon is used to configure cell spedific parameters of a UE's serving cell.
The IE contains parameters which a UE would typically acquire from SSB. MIB or SIBs when
accessing the cell from IDLE. With this IE, the network provides this information in dedicated signally
when configuring a UE with a SCells or with an additional cell group (SCG). It also privides
it for SpCells (MCG and SCG) upon reconfiguration with sync.
ServingCellConfigCommon information element

```
--ASN1START
--TAG--SERVINGCELLCONFIGCOMMON-START
ServingCellConfigCommon ::=  SEQUENCE {
  physCellId  PhysCellId
Optional, -- Cond HOandServCellAdd,
  downlinkConfigCommon  DownlinkConfigCommon
Optional, -- Cond HOandServCellAdd,
  uplinkConfigCommon  UplinkConfigCommon
OPTIONAL, --Need M
  supplementary UplinkConfig
OPTIONAL, -- Need S
  n-TimingAdvanceOffset  ENUMERATED { n0, n25600, n39936 }
OPTIONAL, -- Need S
  ssb-PositionsInBurst  CHOICE }
    shortBitmap  BIT STRING (SIZE (4)),
    mediumBitmap  BIT STRING (SIZE (8)),
    longBitmap  BIT STRING (SIZE (64))
  }
OPTIONAL -- Cond AbsFreqSSB
  ssb-PeriodicityServingCell  ENUMERATED { ms5, ms10, ms20, ms40, ms80, ms160,
spare2, spare1 } OPTIONAL, -- Need S
  dmrs-TypeA-Position  ENUMERATED {pos2, pos3},
  lte-CRS-ToMatchAround  SetupRelease { RateMatchPatternLTE-CRS }
OPTIONAL, --Need M
  ratematchPatternToAddModList  SEQUENCE (SIZE (1..maxNrofRateMatchPattern))
OF RateMatchPattern OPTIONAL, --Need N
  ratematchPatternToReleaseList  SEQUENCE (SIZE (1..maxNrofRateMatchPattern))
OF RateMatchPatternID OPTIONAL, --Need N
  ssbSubcarrierSpacing  subcarrierSpacing
OPTIONAL, -- Cond HOAndServCellWithSSB
  tdd-UL-DL-ConfigurationCommon  TDD-UL-DL-ConfigCommon
OPTIONAL, -- Cond TDD
  ss-PBCH-BlockPower  INTEGER (−60..50),
  ...,
[[
```

```
TABLE 32
  ChannelAccessMode-r16  CHOICE {
  dynamic  NULL,
semistatic  SemiStaticChannelAccessConfig
  }
OPTIONAL, -- Need M
  discoveryBurst-WindowLength-r16  ENUMERATED {s0dot5, s1, s2, s3, s4, s5}
OPTIONAL, -- Need M
ssb-PositionQCL-r16  SSB-PositionQCL-Relationship-r16
OPTION, -- Need M
  IntraCellGuardBandUL-r16  IntraCellGuardBand-r16
OPTIONAL -- Need M
  IntraCellGuardBandDL-r16  IntraCellGuardBand-r16
OPTIONAL -- Need M
  ]]
}
IntraCellGuardBand-r16 ::=  SEQUENCE (SIZE (SIZE (1..ffsvalue)) OF GuardBand-r15 --
FFS upper size 4, assuming 100Mhz cell
GuardBand-r16  ::=  SEQUENCE {
  startCRB-r16  INTEGER (0..ffsValue), --FFS upper range 275
  nrofCRBs-r16  INTEGER (1..ffsValue)
}
--TAG--SERVINGCELLCONFIGCOMMON-STOP
--ASN1STOP
```

TABLE 33
ServingCellConfigCommon field descriptions

channelAccessMode
If the field is configured as “semistatic”, the channel access procedures for semi-static channel occupancy as described in
subclause 4.3 in TS 37.213 are applied. Otherwise, if the field is configured as “dynamic” or if the field is absent, the channel
access procedures in TS 37.213, with exception of subclause 4.3 of TS 37.213, are applied.
dmrs-TypeA-Position
Position of (first) DM-RS for downlink (see TS 38.211 [16], clause 7.4.1.1.1) and uplink (TS 38.211 [16], clause 6.4.1.1.3).
downlinkConfigCommon
The common downlink configuration of the serving cell, including the frequency information configuration and the initial
downlink BWP common configuration. The parameters provided herein should match the parameters configured by MIB
and SIB1 (if provided) of the serving cell, with the exception of controlResourceSetZero and searchSpaceZero which
can be configured in ServingCellConfigCommon even if MiB indicates that they ate absent.
discoveryBurst-WindowLength
Indicates the window length of the discovery burst in ms (see TS 37.213 [48]).
intraCellGuardBandDL
Each value is a CRB index, For every two values, the first/second is the lowest/highest CRB of a guard band between two RB
sets. If not configured, the guard bands are according to the TS 38.101-X).
intraCellGuardBandUL
Each value is a CRB index. For every two values, the first/second is the lowest/highest CRB of a guard band between two RB
sets, if not configured, the guard bands are according to the TS 38.101-X).
longBitmap
Bitmap when maximum number of SS/PBCH blocks per half frame equals to 64 as defined in TS 38.213 [13], clause 4.1.
Ite-CRS-ToMatchAround
Parameters to determine an LTE CRS pattern that the UE shall rate match around.
mediumBitmap
Bitmap when maximum number of SS/PBCH blocks per half frame equals to 8 as defined in TS 38.213 [13], clause 4.1.
n-TimingAdvanceOffset
The N_TA-Offset to be applied for all uplink transmissions on this serving cell. If the field is absent, the UE applies the value
defined for the duplex mode and frequency range of this serving cell. See TS 38.133 [14], table 7.1.2-2.
rateMatchPatternToAddModList
Resources patterns which the UE should rate match PDSCH around. The UE rate matches around the union of all resources
indicated in the rate match patterns. Rate match patterns defined here on cell level apply only to PDSCH of the same
numerology (see TS 38.214 [19], clause 5.1.4.1).
semiStaticChannelAccessConfig
The parameters for semi-static channel access. The network configures this only when channelAccessMode is set to semistatic.
shortBitmap
Bitmap when maximum number of SS/PBCH blocks per half frame equals to 4 as defined in TS 38.213 [13], clause 4.1.
ss-PBCH-BlockPower
Average EPRE of the resources elements that carry secondary synchronization signals in dBm that the NW used for SSB
transmission, see TS 38.213 [3], clause 7.
ssb-periodicityServingCell
The SSB periodicity in ms for the rate matching purpose, if the field is absent, the UE applies the value ms5. (see TS 38.213
[13], clause 4.1)
ssb-PositiontQCL
Indicates the QCL relationship between SSB positions for a neighbor cell as specified in TS 38.213 [13]. cause 4.1.
ssb-PositionsinBurst
Indicates the time domain positions of the transmitted SS-blocks in a half frame with SS/PBCH blocks as defined in TS 38.213
[13]. clause 4.1. The first/leftmost bit corresponds to SS/PBCH block index 0, the second bit corresponds th SS/PBCH block
index 1, and so on. Value 0 in the bitmap indicates that the corresponding SS/PBCH block is not transmitted while value 1
indicates that the corresponding SS/PBCH block is transmitted. The network configures the same pattern in this field as in the
corresponding field in ServingCellConfigCommonSIB. For operation with shared spectrum channel access, only
mediumBitmap is used. The UE assumes that a bit at position k > ssb-PositionQCL is 0
ssbSubcarrierSpacing
Subcarrier spacing of SSB. Only the values 15 kHz or 30 kHz (FR1), and 120 kHz or 240 kHz (FR2) are applicable.
supplementaryUplinkConfig
The network configures this field only if uplinkConfigCommon is configured. If this field is absent, the UE shall release the
supplementaryUplinkConfig and the supplementaryUplink configured in ServingCellConfig of this serving cell, if configured.
tdd-UL-DL-ConfigurationCommon
A cell-specific TDD UL/DL configuration, see TS 38.213 [13], clause 11.1.

TABLE 34

| Conditional Presence | Explanation |
|---|---|
| AbsFreqSSB | The field is absent when |
| | absoluteFrequencySSB in |
| | frequencyinfoDL is absent, |
| | otherwise the field is mandatory |
| | present. |
| HOAndServCellAdd | This field is mandatory present |
| | upon SpCell change and upon |
| | serving cell (PSCell/SCell) addition. |
| | Otherwise, the field is absent. |
| HOAndSerCellWithSSB | This field is mandatory present upon |
| | SpCell change and upon serving cell |
| | (SCell with SSB or PSCell) addition. |
| | Otherwise, the field is absent. |
| TDD | The field is optionally present. |
| | Need R, for TDD cells; otherwise it |
| | is absent. |

For example, ServingCellConfigCommon may be used when SpCell is to be added and/or system information is updated in handover and/or dual connectivity.

For example, in addition to ssb-PositionsInBurst included in ServingCellConfigCommon, ssb-PositionsInBurst (e.g., ssb-PositionsInBurst-16r/ssb-PositionsInBurst-r16) may be indicated. For example, ssb-PositionsInBurst-16r/ssb-PositionsInBurst-r16 may be included in ServingCellConfigCommon.

For example, ServingCellConfigCommon may be a cell-specific parameter provided for each UE. For example, when ServingCellConfigCommon is indicated for the first UE, parameter ssb-PositionsInBurst may be used and indicated. For example, when ServingCellConfigCommon is indicated for the second UE, parameter ssb-PositionsInBurst-16r/ssb-PositionsInBurst-r16 may be used and indicated.

For example, an example of configuration of parameter ssb-PositionsInBurst-16r/ssb-PositionsInBurst-r16 will be described below.

```
ssb-PositionsInBurst-16r SEQUENCE {
  inOneGroup BIT STRING (SIZE (8)),
  groupPresence BIT STRING (SIZE (8)) OPTIONAL --
  Cond Above6GHzOnly (FR2-Only)
},
```

ServingCellConfigCommon needs to contain content of ServingCellConigCommonSIB1, and ssb-PositionsInburst of existing ServingCellConfigCommon may be configured in a different from the SIB1, and unnecessary bit waste may be caused. According to various embodiments of the present disclosure, ssb-PositionsInburst may be configured in a form such as the SIB1 (inOneGroup, groupPresnece), thereby reducing an unnecessary signaling bit.

For example, when ssb-PositionsInBurst is indicated in ServingCellConfigCommon, a UE may perform rate matching and/or SSB-to-RO mapping according to a value of the indicated parameter.

And/or, for example, when ssb-PositionsInBurst-16r/ssb-PositionsInBurst-r16 is indicated in ServingCellConfigCommon, the UE may perform rate matching and/or SSB-to-RO mapping according to a value of the indicated parameter.

According to various embodiments of the present disclosure, new ssb-PositionsInBurst such as ssb-PositionsInBurst-16r/ssb-PositionsInBurst-r16 may be added when a parameter is updated to an additional parameter in existing RACH configuration, thereby overcoming a problem that occurs when the first and second UEs coexis.

For example, when a period is indicated by 10 ms in existing RACH configuration, if the parameter is updated to an additional parameter at a period of 20 ms, an RO of 10 ms needs to be allowed for the first UE, and thus when a period increases to 20 ms, it may be meaningless.

When a new parameter according to various embodiments of the present disclosure is introduced, for example, even if the number of SSBs used by a network is actually L (L being a natural number, e.g., L=1), the network may indicate that the number ofATSSs is M (M being a natural number, e.g., M=2) for the first UE and may indicate that the number ofATSSs is N (N being a natural number, e.g., N=1) for the second UE.

For example, assuming that SSB-to-RO mapping is one-to-one (1:1) mapping, the first UE may map SSB#0 and SSB#1 to an RO present every 10 ms, but only SSB#0 is sensed with regard to the reception sensitivity of an actually received SSB, and thus the first UE may select only an RO mapped to SSB#0, thereby achieving a similar effect to allocation of an RACH period of 20 ms. For example, the second UE may map SSB#0 to an RO present every 20 ms. As a result, according to various embodiments of the present disclosure, an RACH of a new period may be indicated to both of the first UE and the second UE.

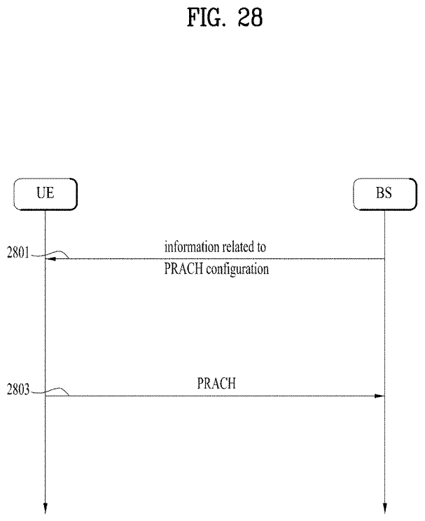

FIG. 28 is a schematic diagram showing an operating method of a UE and a BS according to various embodiments of the present disclosure.

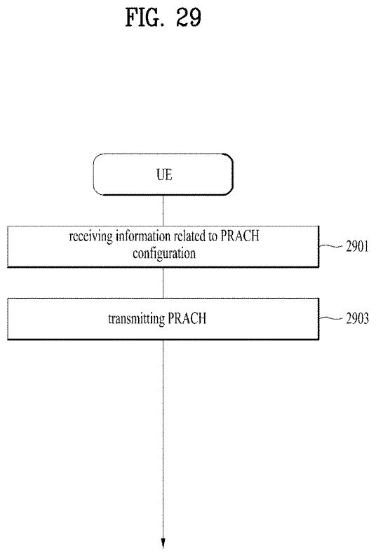

FIG. 29 is a flowchart showing an operating method of a UE according to various embodiments of the present disclosure.

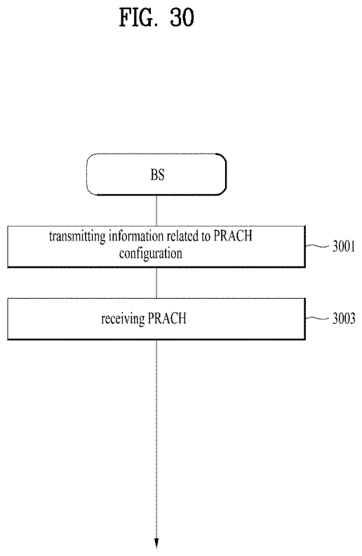

FIG. 30 is a flowchart showing an operating method of a BS according to various embodiments of the present disclosure.

Referring to FIGS. 28 to 30, in operations 2801, 2901, and 3001 according to an exemplary embodiment, the BS may transmit configuration information related to a PRACH, and the UE may receive the same.

In operations 2803, 2903, and 3003 according to an exemplary embodiment, the UE may transmit the PRACH, and the BS may receive the same. For example, the PRACH may be transmitted and received in a PRACH occasion included in one or more PRACH occasions configured based on a plurality of parameters related to configuration information.

According to exemplary embodiment, the BS may transmit information related to overriding of one or more first values of one or more parameters among a plurality of parameters with one or more second values, and the UE may receive the transmitted information. In this case, one or more PRACH occasions may be configured based on (i) a parameter except for the one or more parameters among the plurality of parameters and (ii) the one or more parameters overridden by the one or more second values.

Since examples of the above-described proposal method may also be included in one of implementation methods of the various embodiments of the present disclosure, it is obvious that the examples are regarded as a sort of proposed methods. Although the above-proposed methods may be independently implemented, the proposed methods may be implemented in a combined (aggregated) form of a part of the proposed methods. A rule may be defined such that the BS informs the UE of information as to whether the proposed methods are applied (or information about rules of the proposed methods) through a predefined signal (e.g., a physical layer signal or a higher-layer signal).

### 4. Exemplary Configurations of Devices Implementing Various Embodiments of the Present Disclosure

### 4.1. Exemplary Configurations of Devices to Which Various Embodiments Of the Present Disclosure are Applied

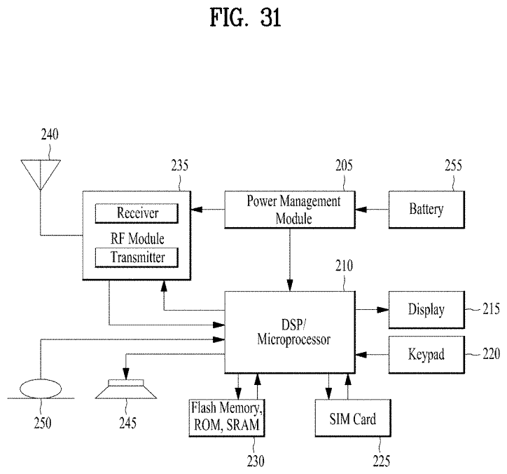

FIG. 31 is a diagram illustrating devices that implement various embodiments of the present disclosure.

The devices illustrated in FIG. 31 may be a UE and/or a BS (e.g., eNB or gNB) adapted to perform the afore-described mechanisms, or any devices performing the same operation.

Referring to FIG. 31, the device may include a digital signal processor (DSP)/microprocessor 210 and a radio frequency (RF) module (transceiver) 235. The DSP/microprocessor 210 is electrically coupled to the transceiver 235 and controls the transceiver 235. The device may further include a power management module 205, a battery 255, a display 215, a keypad 220, a SIM card 225, a memory device 230, an antenna 240, a speaker 245, and an input device 250, depending on a designer's selection.

Particularly, FIG. 31 may illustrate a UE including a receiver 235 configured to receive a request message from a network and a transmitter 235 configured to transmit timing transmission/reception timing information to the network. These receiver and transmitter may form the transceiver 235. The UE may further include a processor 210 coupled to the transceiver 235.

Further, FIG. 31 may illustrate a network device including a transmitter 235 configured to transmit a request message to a UE and a receiver 235 configured to receive timing transmission/reception timing information from the UE. These transmitter and receiver may form the transceiver 235. The network may further include the processor 210 coupled to the transceiver 235. The processor 210 may calculate latency based on the transmission/reception timing information.

A processor included in a UE (or a communication device included in the UE) and a BE (or a communication device included in the BS) according to various embodiments of the present disclosure may operate as follows, while controlling a memory.

According to various embodiments of the present disclosure, a UE or a BS may include at least one transceiver, at least one memory, and at least one processor coupled to the at least one transceiver and the at least one memory. The at least one memory may store instructions causing the at least one processor to perform the following operations.

A communication device included in the UE or the BS may be configured to include the at least one processor and the at least one memory. The communication device may be configured to include the at least one transceiver, or may be configured not to include the at least one transceiver but to be connected to the at least one transceiver.

According to various embodiments of the present disclosure, one or more processors included in a UE (or one or more processors of a communication device included in the UE) may receive configuration information related to a physical random access channel (PRACH).

According to various embodiments of the present disclosure, one or more processors included in the UE may transmit the PRACH in a PRACH occasion included one or more PRACH occasions configured based on a plurality of parameters related to the configuration information.

According to an exemplary embodiment, based on reception of information related to overriding of one or more first values of one or more parameters among the plurality of parameters with one or more second values, the one or more PRACH occasions may be configured based on (i) a parameter except for the one or more parameters among the plurality of parameters and (ii) the one or more parameters overridden with the one or more second values.

According to various embodiments of the present disclosure, one or more processors included in a BS (or one or more processors of a communication device included in the BS) may transmit configuration information related to a physical random access channel (PRACH).

According to various embodiments of the present disclosure, one or more processors included in a BS may receive the PRACH in a PRACH occasion included in one or more PRACH occasions based on a plurality of parameters related to the configuration information.

According to an exemplary embodiment, in response to reception of information related to overriding of one or more first values of one or more parameters among the plurality of parameters with one or more second values, the one or more PRACH occasions may be based on (i) a parameter except for the one or more parameters among the plurality of parameters and (ii) the one or more parameters overridden with the one or more second values.

A more specific operation of a processor included in a BS and/or a UE according to various embodiments of the present disclosure may be described and performed based on the afore-described clause 1 to clause 3.

Unless contradicting with each other, various embodiments of the present disclosure may be implemented in combination. For example, the BS and/or the UE according to various embodiments of the present disclosure may perform operations in combination of the embodiments of the afore-described clause 1 to clause 3, unless contradicting with each other.

### 4.2. Example of Communication System to which Various Embodiments of the Present Disclosure are Applied

In the present specification, various embodiments of the present disclosure have been mainly described in relation to data transmission and reception between a BS and a UE in a wireless communication system. However, various embodiments of the present disclosure are not limited thereto. For example, various embodiments of the present disclosure may also relate to the following technical configurations.

The various descriptions, functions, procedures, proposals, methods, and/or operational flowcharts of the various embodiments of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

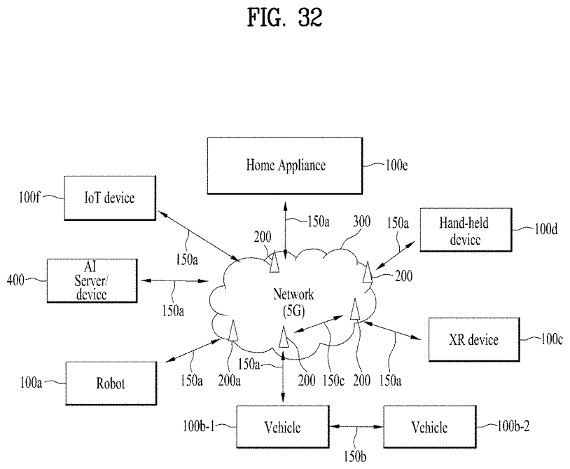

FIG. 32 illustrates an exemplary communication system to which various embodiments of the present disclosure are applied.

Referring to FIG. 32, a communication system 1 applied to the various embodiments of the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul(IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the various embodiments of the present disclosure.

### 4.2.1 Example of Wireless Devices to which Various Embodiments of the Present Disclosure are Applied

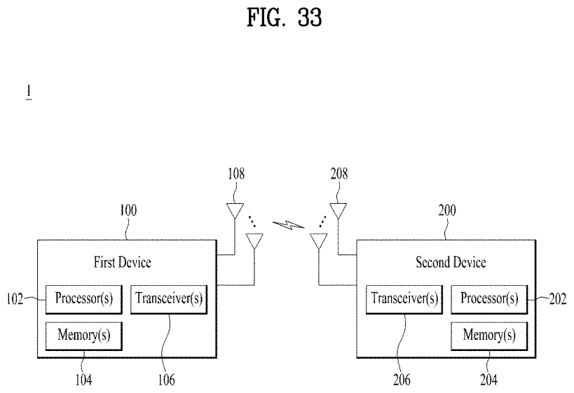

FIG. 33 illustrates exemplary wireless devices to which various embodiments of the present disclosure are applicable.

Referring to FIG. 33, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 32.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the various embodiments of the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the various embodiments of the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

According to various embodiments of the present disclosure, one or more memories (e.g., 104 or 204) may store instructions or programs which, when executed, cause one or more processors operably coupled to the one or more memories to perform operations according to various embodiments or implementations of the present disclosure.

According to various embodiments of the present disclosure, a computer-readable storage medium may store one or more instructions or computer programs which, when executed by one or more processors, cause the one or more processors to perform operations according to various embodiments or implementations of the present disclosure.

According to various embodiments of the present disclosure, a processing device or apparatus may include one or more processors and one or more computer memories connected to the one or more processors. The one or more computer memories may store instructions or programs which, when executed, cause the one or more processors operably coupled to the one or more memories to perform operations according to various embodiments or implementations of the present disclosure.

### 4.2.2. Example of using Wireless Devices to which Various Embodiments of the Present Disclosure are Applied

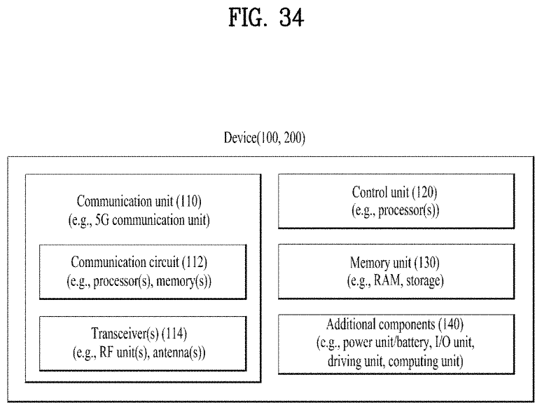

FIG. 34 illustrates other exemplary wireless devices to which various embodiments of the present disclosure are applied. The wireless devices may be implemented in various forms according to a use case/service (see FIG. 32).

Referring to FIG. 34, wireless devices 100 and 200 may correspond to the wireless devices 100 and 200 of FIG. 33 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 33. For example, the transceiver(s) 114 may include the one or more transceivers 106 and 206 and/or the one or more antennas 108 and 208 of FIG. 33. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 32), the vehicles (100b-1 and 100b-2 of FIG. 32), the XR device (100c of FIG. 32), the hand-held device (100d of FIG. 32), the home appliance (100e of FIG. 32), the IoT device (100f of FIG. 32), a digital broadcast terminal, a hologram device, a public safety device, an MTC device, a medicine device, a fintech device (or a finance device), a security device, a climate/environment device, the AI server/device (400 of FIG. 32), the BSs (200 of FIG. 32), a network node, etc. The wireless device may be used in a mobile or fixed place according to a use-example/service.

In FIG. 34, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 34 will be described in detail with reference to the drawings.

### 4.2.3. Example of Portable Device to which Various Embodiments of the Present Disclosure are Applied

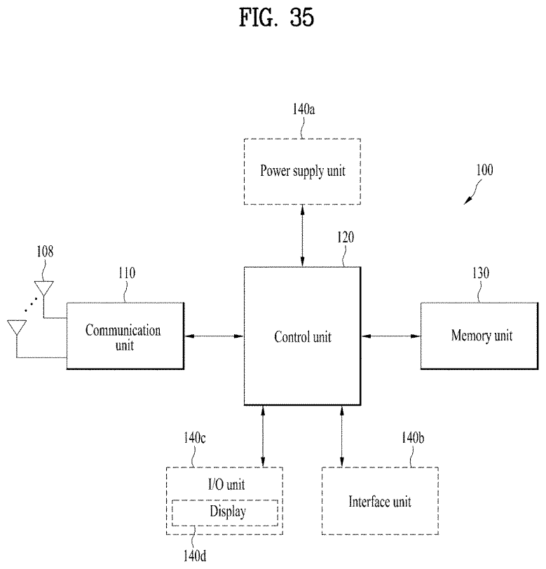

FIG. 35 illustrates an exemplary portable device to which various embodiments of the present disclosure are applied. The portable device may be any of a smartphone, a smartpad, a wearable device (e.g., a smartwatch or smart glasses), and a portable computer (e.g., a laptop). A portable device may also be referred to as mobile station (MS), user terminal (UT), mobile subscriber station (MSS), subscriber station (SS), advanced mobile station (AMS), or wireless terminal (WT).

Referring to FIG. 35, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 34, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

### 4.2.4. Example of Vehicle or Autonomous Driving Vehicle to which Various Embodiments of the Present Disclosure

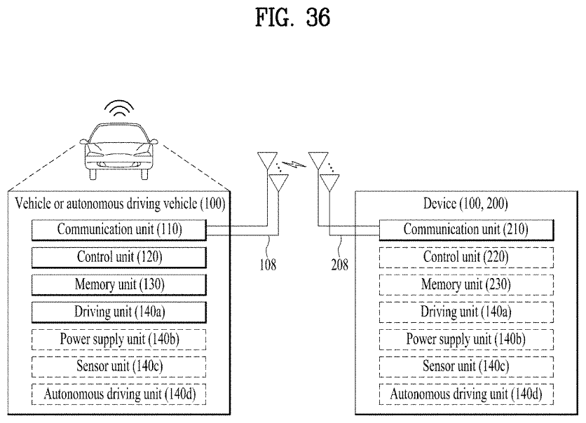

FIG. 36 illustrates an exemplary vehicle or autonomous driving vehicle to which various embodiments of the present disclosure. The vehicle or autonomous driving vehicle may be implemented as a mobile robot, a car, a train, a manned/unmanned aerial vehicle (AV), a ship, or the like.

Referring to FIG. 36, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 34, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

In summary, various embodiments of the present disclosure may be implemented through a certain device and/or UE.

For example, the certain device may be any of a BS, a network node, a transmitting UE, a receiving UE, a wireless device, a wireless communication device, a vehicle, a vehicle equipped with an autonomous driving function, an unmanned aerial vehicle (UAV), an artificial intelligence (AI) module, a robot, an augmented reality (AR) device, a virtual reality (VR) device, and other devices.

For example, a UE may be any of a personal digital assistant (PDA), a cellular phone, a personal communication service (PCS) phone, a global system for mobile (GSM) phone, a wideband CDMA (WCDMA) phone, a mobile broadband system (MBS) phone, a smartphone, and a multi mode-multi band (MM-MB) terminal.

A smartphone refers to a terminal taking the advantages of both a mobile communication terminal and a PDA, which is achieved by integrating a data communication function being the function of a PDA, such as scheduling, fax transmission and reception, and Internet connection in a mobile communication terminal. Further, an MM-MB terminal refers to a terminal which has a built-in multi-modem chip and thus is operable in all of a portable Internet system and other mobile communication system (e.g., CDMA 2000, WCDMA, and so on).

Alternatively, the UE may be any of a laptop PC, a hand-held PC, a tablet PC, an ultrabook, a slate PC, a digital broadcasting terminal, a portable multimedia player (PMP), a navigator, and a wearable device such as a smartwatch, smart glasses, and a head mounted display (HMD). For example, a UAV may be an unmanned aerial vehicle that flies under the control of a wireless control signal. For example, an HMD may be a display device worn around the head. For example, the HMD may be used to implement AR or VR.

A wireless communication technology for implementing various embodiments of the present disclosure may include Narrowband Internet of Things for low power communication as well as LTE, NR, and 6G. In this case, for example, the NB-IoT technology may be an example of a Low Power Wide Area Network (LPWAN) technology and may be implemented in standards such as LTE Cat NB1 and/or LTE Cat NB2, and is not limited to the above-described name. Additionally or alternatively, the wireless communication technology implemented in a wireless device according to various embodiments of the present disclosure may perform communication based on the LTE-M technology. In this case, for example, the LTE-M technology may be an example of the LPWAN technology and may be called various terms such as enhanced Machine Type Communication (eMTC). For example, the LTE-M technology may be implemented as at least one of various standards such as 1) LTE CAT 0, 2) LTE Cat M1, 3) LTE Cat M2, 4) LTE non-BL(non-Bandwidth Limited), 5) LTE-MTC, 6) LTE Machine Type Communication, and/or 7) LTE M and may not be limited to the aforementioned terms. Additionally or alternatively, the wireless communication technology implemented in the wireless device according to various embodiments of the present disclosure may include at least one of ZigBee, Bluetooth, or Low Power Wide Area Network (LPWAN) in consideration of low power communication and is not limited to the aforementioned terms. For example, the ZigBee technology may generate personal area networks (PAN) related to small/low-power digital communication based on various standards such as IEEE 802.15.4 and may be called various terms.

Various embodiments of the present disclosure may be implemented in various means. For example, various embodiments of the present disclosure may be implemented in hardware, firmware, software, or a combination thereof.

In a hardware configuration, the methods according to exemplary embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the various embodiments of the present disclosure may be implemented in the form of a module, a procedure, a function, etc. performing the above-described functions or operations. A software code may be stored in the memory 50 or 150 and executed by the processor 40 or 140. The memory is located at the interior or exterior of the processor and may transmit and receive data to and from the processor via various known means.

Those skilled in the art will appreciate that the various embodiments of the present disclosure may be carried out in other specific ways than those set forth herein without departing from the spirit and essential characteristics of the various embodiments of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment of the present disclosure or included as a new claim by a subsequent amendment after the application is filed.

### INDUSTRIAL AVAILABILITY

The various embodiments of present disclosure are applicable to various wireless access systems including a 3GPP system, and/or a 3GPP2 system. Besides these wireless access systems, the various embodiments of the present disclosure are applicable to all technical fields in which the wireless access systems find their applications. Moreover, the proposed method can also be applied to mmWave communication using an ultra-high frequency band.

1. A method performed by a user equipment (UE) in a wireless communication system, the method comprising:
receiving configuration information related to a physical random access channel (PRACH); and
transmitting the PRACH in a PRACH occasion included in one or more PRACH occasions configured based on a plurality of parameters related to the configuration information,
wherein, based on reception of information related to overriding of one or more first values of one or more parameters among the plurality of parameters with one or more second values, the one or more PRACH occasions are configured based on (i) a parameter except for the one or more parameters among the plurality of parameters and (ii) the one or more parameters overridden with the one or more second values.

2. The method of claim 1, wherein the one or more first values satisfy preconfigured correspondence between the one or more first values and the configuration information identified based on the configuration information and a preconfigured PRACH configuration table.

3. The method of claim 1, wherein the information related to overriding comprises information for the one or more parameters as the one or more second values.

4. The method of claim 1, wherein:
the one or more PRACH occasions are included in one PRACH slot; and
based on reception of information for some PRACH occasions of the one or more PRACH occasions, the PRACH is transmitted in the PRACH occasion included in the some PRACH occasions and a physical uplink shared channel (PUSCH) is transmitted in a PRACH occasion except for the some PRACH occasions among the one or more PRACH occasions, or the PRACH is transmitted in the PRACH occasion except for the some PRACH occasions among the one or more PRACH occasions, and a PUSCH is transmitted in some PRACH occasions.

5. The method of claim 1, wherein:
transmission of the PRACH comprises transmission of a PRACH preamble;
after the PRACH preamble is transmitted, a physical uplink shared channel (PUSCH) is transmitted;
based on reception of the information related to overriding, transmission of the PRACH preamble and transmission of the PUSCH are consecutively configured on a time domain or a timing gap between transmission of the PRACH preamble and transmission of the PUSCH is configured to be less than 16 micro-second (us).

6. The method of claim 5, wherein:
the PRACH preamble and the PUSCH are included in a message A; and
the message A is transmitted based on one time channel access procedure (CAP) for access to a channel included within an unlicensed band.

7. An apparatus configured to operate in a wireless communication system, the apparatus comprising:
a memory; and
one or more processors connected to the memory,
wherein the one or more processors are configured to:
receive configuration information related to a physical random access channel (PRACH); and
transmit the PRACH in a PRACH occasion included in one or more PRACH occasions configured based on a plurality of parameters related to the configuration information,
wherein based on reception of information related to overriding of one or more first values of one or more parameters among the plurality of parameters with one or more second values, the one or more PRACH occasions are configured based on (i) a parameter except for the one or more parameters among the plurality of parameters and (ii) the one or more parameters overridden with the one or more second values.

8. The apparatus of claim 7, wherein the one or more first values satisfy preconfigured correspondence between the one or more first values and the configuration information identified based on the configuration information and a preconfigured PRACH configuration table.

9. The apparatus of claim 7, wherein the information related to overriding includes information for the one or more parameters as the one or more second values.

10. The apparatus of claim 7, wherein:
the one or more PRACH occasions are included in one PRACH slot; and
based on reception of information for some PRACH occasions of the one or more PRACH occasions, the PRACH is transmitted in the PRACH occasion included in the some PRACH occasions and a physical uplink shared channel (PUSCH) is transmitted in a PRACH occasion except for the some PRACH occasions among the one or more PRACH occasions, or the PRACH is transmitted in the PRACH occasion except for the some PRACH occasions among the one or more PRACH occasions, and a PUSCH is transmitted in some PRACH occasions.

11. The apparatus of claim 7, wherein the apparatus is configured to communicate with one or more of a mobile UE, a network, and an autonomous driving vehicle other than a vehicle comprising the apparatus.

12. A method performed by a base station (BS) in a wireless communication system, the method comprising:
transmitting configuration information related to a physical random access channel (PRACH); and
receiving the PRACH in a PRACH occasion included in one or more PRACH occasion based on a plurality of parameters related to the configuration information,
wherein, in response to transmission of information related to overriding of one or more first values of one or more parameters among the plurality of parameters with one or more second values, the one or more PRACH occasions are based on (i) a parameter except for the one or more parameters among the plurality of parameters and (ii) the one or more parameters overridden with the one or more second values.

13. An apparatus configured to operate in a wireless communication system, the apparatus comprising:
a memory; and
one or more processors connected to the memory,
wherein the one or more processors are configured to:
transmit configuration information related to a physical random access channel (PRACH); and
receive the PRACH in a PRACH occasion included in one or more PRACH occasion based on a plurality of parameters related to the configuration information,
wherein in response to transmission of information related to overriding of one or more first values of one or more parameters among the plurality of parameters with one or more second values, the one or more PRACH occasions are based on (i) a parameter except for the one or more parameters among the plurality of parameters and (ii) the one or more parameters overridden with the one or more second values.

14-15. (canceled)
